(19) United States
(12) Patent Application Publication
(10) Pub. No.: US 2025/0367633 A1
(43) Pub. Date: Dec. 4, 2025

(54) COMPOSITIONS AND METHODS FOR POLYMER-MODIFIED LITHIUM/ALUMINUM LAYERED DOUBLE HYDROXIDE (Li/Al-LDH)

(71) Applicant: VIRGINIA TECH INTELLECTUAL PROPERTIES, INC., Blacksburg, VA (US)

(72) Inventors: Wencai Zhang, Blacksburg, VA (US); Yanan Pan, Blacksburg, VA (US)

(21) Appl. No.: 19/220,546

(22) Filed: May 28, 2025

Related U.S. Application Data
(60) Provisional application No. 63/654,487, filed on May 31, 2024.

(51) Int. Cl. B01J 20/08; B01J 20/26; B01J 20/32; C22B 3/24; C22B 26/12

(52) U.S. Cl. CPC B01J 20/08; B01J 20/261; B01J 20/262; B01J 20/3204; B01J 20/327; B01J 20/3272; C22B 3/24; C22B 26/12

(57) ABSTRACT

The present disclosure pertains to methods for enhancing the properties of conventional Li/Al-LDH by integrating polymers to provide compositions comprising a Li/Al-LDH material and a polymer. The present disclosure further pertains to methods of using such polymer-modified-LDH to improve lithium adsorption and extraction performance. The disclosed methods can comprise incorporating the polymer during the precipitation reaction or by mixing the Li/Al-LDH product with a polymer solution under specific conditions. During the lithium extraction process, the disclosed compositions comprising a Li/Al-LDH material and a polymer can be used as an excellent lithium adsorbent to capture lithium ions from low-concentration lithium resources due to its improved physicochemical properties. The disclosed compositions comprising a Li/Al-LDH material and a polymer provides compositions for lithium extraction from low concentration resources, as well as expands the scope of lithium adsorbent material development.

### CROSS REFERENCE TO RELATED APPLICATIONS

This application claims the benefit of U.S. Provisional Application Ser. No. 63/654,487, filed May 31, 2024, which is incorporated herein by reference in its entirety.

### BACKGROUND

The global demand for lithium has surged recently, driven by its critical importance in various industries such as battery technology, electronics, and renewable energy storage systems. It has been reported that the need for lithium carbonate will escalate from 265,000 tons in 2015 to an anticipated 498,000 tons by 2025. Moreover, the lack of lithium selectivity in the traditional hydrometallurgical methods can complicate the purification of lithium compounds in subsequent steps. Therefore, developing a highly selective and environmentally friendly technique for lithium recovery is essential.

So far, several lithium extraction methods have been reported, including adsorption, ion-exchange, solvent extraction, membranes, and electrochemical methods. Among these, the adsorption is recognized globally as the premier commercial technique due to its high selectivity for lithium ions, straightforward operation, and minimal energy consumption. This technology uses an adsorbent with high lithium selectivity and stable chemical properties to adsorb lithium ions, thereby achieving the effect of separating them from impurity ions, and finally further elutes the adsorbed lithium to realize the recovery of lithium resources. The key to this method lies in the choice of adsorbent. The lithium adsorbents used are generally divided into organic adsorbents and inorganic adsorbents. It has been proven that organic adsorbents have poor adsorption and extraction effects on metal cations, and there are not many organic adsorbents that can be directly used to extract lithium. Inorganic adsorbents can be mainly divided into manganese ion sieves, titanium ion sieves and lithium/aluminum layered double hydroxide (Li/Al-LDH). Specifically, lithium/aluminum layered double hydroxide (Li/Al-LDH) have demonstrated efficacy in lithium adsorption from low grade lithium resources.

Li/Al-LDH, as a unique class of monovalent and trivalent hydroxides, has strong adjustability in composition and structure. The chemical expression of Li/Al-LDH is LiX·mAl(OH)₃·nH₂O, where “X” is Cl⁻, Br⁻ or NO₃⁻. As shown in FIG. 1, two-thirds of the octahedral holes in the crystal structure are occupied by Al atoms, and the remaining half is occupied by Li atoms, while anions are inserted between the sheets to balance the charge, making the electrical neutrality of the whole. During the adsorption/desorption process, LiCl intercalates/extracts from the adsorbent to maintain charge balance. To enhance or introduce the properties of LDH, several modifications have been reported, involving intercalation, surface coating, hybrid assembly, size and morphology, and defect introduction. Therefore, given the versatility in the structure and chemical composition of Li/Al-LDH, incorporating new functional groups to modify its physicochemical characteristics presents significant research interest.

Polymers, large molecules composed of repeated subunits known as monomers linked via chemical bonds, are cornerstone elements in the realm of materials science today. Their application spans a broad spectrum, from everyday items to advanced technological uses. Properties such as their relatively low density, excellent moldability, and robust strength and durability, position polymers as key agents in material modification. They serve as effective surface coatings, enhancing material aesthetics, durability against weather, and resistance to chemicals. As the foundational substance in composite materials, polymers contribute to elevating the structural integrity, resilience, and reduction in weight of these materials.

Therefore, based on the considerable promise of polymer modification for Li/Al-LDH, the present disclosure employs polymers to modify the Li/Al-LDH which is prepared via one-step coprecipitation method, thereby improving its characteristics and ability in extracting low-concentration lithium resources.

Despite advances in research directed to lithium extraction, particularly low-concentration lithium sources, there is still a scarcity of materials and methods that are both efficient and cost-effective, particularly for use with low-concentration lithium sources. These needs and other needs are satisfied by the present disclosure.

### SUMMARY

In accordance with the purpose(s) of the disclosure, as embodied and broadly described herein, the disclosure, in one aspect, relates to compositions comprising a Li/Al-LDH substrate and a polymer that have improved properties and performance for extracting lithium from a source, e.g., a water byproduct from mining or shale gas production; a method compositions comprising a Li/Al-LDH substrate and a polymer that confers enhanced physicochemical properties for improved extraction of lithium in low concentration lithium sources for the purpose of lithium extraction and recovery.

Disclosed are compositions comprising: a Li/Al-LDH substrate; and a polymer attached to the Li/Al-LDH substrate; wherein the composition has improved affinity for extraction of lithium from a lithium-containing source material.

Also disclosed are methods for preparing a composition comprising a Li/Al-LDH substrate and a polymer, the method comprising the steps: providing a lithium and aluminum salt solution comprising the Li/Al-LDH substrate and a polymer solution comprising a polymer; pumping the lithium and aluminum salt solution and the polymer solution into an alkali solution within a container, thereby forming a slurry; allowing the lithium and aluminum salt solution and the polymer solution to be in contact with each other in the slurry at a temperature and for a time suitable for completion of formation of the composition comprising a Li/Al-LDH substrate and a polymer; washing the slurry with deionized water; and drying the slurry forming a powder product comprising the composition comprising a Li/Al-LDH substrate and a polymer; thereby forming the composition comprising a Li/Al-LDH substrate and a polymer; wherein the composition comprising a Li/Al-LDH substrate and a polymer comprises enhanced adsorption of lithium.

Also disclosed are methods for the extraction of lithium, the method comprising: providing a lithium adsorbent composition; and contacting the disclosed lithium absorbent composition with a water-byproduct obtained from shale gas production; wherein the disclosed lithium absorbent composition is the composition of any one of claims 1-41 or the composition made by the method of any one of claims 42-71 as a lithium adsorbent during a lithium adsorption process.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-D shows representative data as follows: FIG. 1A shows a representative comparison of the lithium adsorption performance; FIG. 1B shows a representative separation coefficient of PEG400@LDH; FIG. 1C shows a representative separation coefficient of PEG2000@LDH; (d) Temperature and L/S ratio effects during modification process on lithium adsorption capacity.

FIGS. 2A-H shows representative data pertaining to morphological structures obtained by various methods (SEM, TEM, HRTEM, and SAED) of the unmodified (0% PEG400@LDH) and modified (10% PEG400@LDH) materials.

FIGS. 3A-H shows representative data as follows: FIG. 3A shows representative N₂ adsorption/desorption isotherms at 77 K; FIG. 3B shows representative pore volume distributions and comparison of the surface area; FIG. 3C shows a representative vibration density data; FIG. 3D shows a representative surface energy data; FIG. 3E shows representative TGA data of 0% PEG400@LDH and 10% PEG400@LDH; FIG. 3F shows representative solid-state ¹³C NMR spectra of 10% PEG400@LDH; FIG. 3G shows representative Solid-state ²⁷Al NMR spectra of different materials before and after modification with the 10% PEG400 solution; and FIG. 3H shows representative XPS full survey spectrum and high-resolution scan results of different samples.

FIGS. 4A-B shows (a) Optimized arrangement structure of the system; (b) Lithium binding energy changes before and after modification.

FIGS. 5A-B shows (a) Lithium adsorption capacity under different initial pH conditions; (b) Zeta potential of different samples. (Note: 0% PEG400@LDH-Li and 10% PEG400@LDH-Li mean the adsorbents after lithium adsorption.)

FIGS. 6A-C shows (a) Lithium adsorption kinetics under different L/S ratios; (b) fitting results using pseudo-first-order and pseudo-second-order models; and (c) Lithium adsorption isotherms at 293 K, 313 K, and 333 K.

FIGS. 7A-D shows (a) XRD spectra; (b) FTIR results; (c) XPS full survey spectrum; and (d) C 1s, Al 2p, O 1s high-resolution scanning results before and after lithium adsorption using 10% PEG400@LDH.

FIGS. 8A-C shows the effects of (a) Li⁺ concentration, (b) L/S ratio, and (c) temperature on the lithium desorption process.

FIG. 9 shows a schematic diagram of lithium extraction process using 10% PEG400@LDH.

FIG. 10 shows lithium adsorption cyclic performance and morphological variation using 10% PEG400@LDH.

FIGS. 11A-C shows (a) Lithium adsorption performance comparison of adsorbents synthesized using the different methods; (b) Particle size comparison of the different adsorbents; (c) XRD spectrums comparison of the different adsorbents.

FIGS. 12A-C shows (a) Lithium adsorption performance comparison of the adsorbents synthesized using PAA solutions of different concentrations; (b) Particle size comparison of the different adsorbents; (c) XRD spectrums comparison of the different adsorbents.

FIGS. 13A-C shows (a) Lithium adsorption performance comparison of the adsorbents synthesized at different LDH powder dosages under 293 K, 313 K, and 333 K; (b) Particle size comparison of the different adsorbents; (c) XRD spectrums comparison of the different adsorbents.

FIGS. 14A-G shows (a-b) FESEM; (c) TEM; (d) HRTEM; (e) SAED; (f) HAADF; (g) EDS mapping and atomic fraction.

FIGS. 15A-I shows (a) XRD spectrums; (b) FTIR spectrums; (c) TGA curves; (d) Particle size distributions; (e) D80 values; (f) Zeta potentials; (g) N₂ adsorption and desorption isotherms; (h) Micro-mesoporous size distributions; (i) Surface aera of 0% PAA@LDH and 2.5% PAA@LDH.

FIGS. 16A-B shows (a) Optimized arrangement structure and three-dimension electronic density maps; (b) Partial density of states for 0% PAA@LDH (left) and 2.5% PAA@LDH (right).

FIGS. 17A-H shows (a) pH effect on lithium adsorption; (b) Adsorption kinetics under different L/S ratios; (c) Pseudo-first-order model fitting results. (d) Pseudo-second-order model fitting results; (e) Temperature and L/S ratio effects on lithium adsorption; (f) Adsorption isotherms at 293 K; (g) Distribution coefficients; (h) Selectivity factor of 2.5% PAA@LDH towards cations in Li/Me binary solutions with different initial lithium concentrations (Solid lines refer to the left vertical coordinate, while dash lines refer to the right vertical coordinate).

FIGS. 18A-G shows (a) Effect of L/S ratio, (b) temperature, (c) Li⁺ concentration, and (d) NaOH concentration on lithium desorption amount; (e) Lithium adsorption/desorption performance in different cycles; (f) FTIR spectrums before and after cycles; (g) Schematic diagram of lithium extraction mechanism using 2.5% PAA@LDH.

FIGS. 19A-19D show representative date pertaining to structural morphology and particle size distribution of disclosed absorbents. FIG. 19A-19B show, respectively, SEM photos of PEG400@LDH and PEG2000@LDH prepared under different PEG concentrations.

FIGS. 19C-19D show representative particle size distribution comparison of adsorbents synthesized under 293 K, 313 K, and 333 K using different disclosed methods.

FIGS. 20A-20B show representative date pertaining to preparation of disclosed absorbents prepared using different solvents: FIG. 20A prepared using deionized water (DIW) as a solvent in the preparation or FIG. 20B prepared using ethanol as a solvent in the preparation.

FIGS. 21A-21B show representative FESEM images of a disclosed absorbent (0% PAA@LDH).

FIG. 22 shows a representative Van't Hoff plot calculated of a disclosed absorbent (2.5% PAA@LDH).

FIGS. 23A-23B show representative particle size distribution data comparing disclosed adsorbents synthesized at 293 K, 313 K, and 333 K at different LDH powder loadings: FIG. 23A LDH powder loading of 10 mL/g; and FIG. 23B LDH powder loading of 60 mL/g.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used herein, the term “and/or” includes any and all combinations of one or more of the associated listed items. Expressions such as “at least one of,” when preceding a list of elements, modify the entire list of elements and do not modify the individual elements of the list.

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used in the specification and the appended claims, the singular forms “a,” “an” and “the” include plural referents unless the context clearly dictates otherwise. Thus, for example, reference to “a layered hydroxide,” “a transition metal oxide (TMO),” or “a perovskite oxide,” includes, but is not limited to, two or more such layered hydroxides, transition metal oxides (TMOs), or perovskite oxides, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The terms “disclosed absorbent”, “disclosed lithium absorbent”, “polymer modified-Li/Al-LDH material”, and “a composition comprising a Li/Al-LDH substrate and a polymer” can be used interchangeably and refer to a disclosed material comprising a Li/Al-LDH substrate and a polymer that can be used as an absorbent, in particular, an absorbent for lithium that can extract lithium from low concentration lithium sources.

The terms “Li/Al-LDH substrate” and “Li/Al-LDH powder” can be used interchangeably herein and refer to a Li/Al-LDH material that can be powder, a powder dispersed in a slurry or suspension, and the like which is modified by the disclosed methods herein to comprise a polymer. In some instances a Li/Al-LDH substrate can be in the form of a “Li/Al-LDH salt” or a solution comprising a Li/Al-LDH salt.

The term “lithium source” is used herein to refer to a source material or feedstock from which lithium can be extracted using the disclosed methods for extraction of lithium utilizing the disclosed compositions comprising a Li/Al-LDH substrate and a polymer, e.g., a water-byproduct or product obtained from shale gas extraction or operations, or other lithium-containing byproduct thereof. A further example of a lithium source is a water-byproduct or product of a mining operation.

The term “contacting” as used herein refers to bringing a disclosed Li/Al-LDH substrate in proximity to disclosed polymer as indicated by the context. For example, Li/Al-LDH substrate contacting disclosed polymer refers to the Li/Al-LDH substrate being in proximity to the polymer analyte interacting and binding to the Li/Al-LDH substrate via ionic, dipolar and/or van der Waals interactions. In some instances, contacting can comprise both physical and chemical interactions between the indicated components, including a chemical reaction comprising formation of covalent bonds. That is, it is to be understood that chemical interactions can comprise a combination of covalent and non-covalent interactions, including one or more of ionic, dipolar, van der Waals interactions, and the like.

As used herein, the term “effective amount” refers to an amount that is sufficient to achieve the desired modification of a chemical and/or physical property of the composition or material. For example, an “effective amount” of a Li/Al-LDH substrate and polymer in a disclosed composition refers to an amount that is sufficient to achieve the desired improvement in the property modulated by modifying the Li/Al-LDH substrate with the polymer, e.g. achieving the desired level of improvement of lithium extraction form a lithium-containing source material such as a water-byproduct from a mining operation or shale gas production operation. The specific level in terms of wt % in a composition required as an effective amount will depend upon a variety of factors including the amount and type of Li/Al-LDH substrate, amount and type of polymer and the like.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

### B. Compositions

In one aspect, the disclosure relates to disclosed compositions comprising a Li/Al-LDH substrate and a polymer attached to the Li/Al-LDH substrate; wherein the composition has improved affinity for extraction of lithium from a lithium-containing source material. It is understood that “attached” can comprise covalent, non-covalent, and combinations thereof in terms of the attachment of Li/Al-LDH substrate to the polymer.

The advantages of the disclosed compositions include: (a) the lithium extraction performance is improved compared to the material that has not been modified, providing a brand-new adsorbent for the lithium resource recycling market; (b) the material itself can be recycled; and (c) the desorption process, during use of the disclosed compositions for lithium extraction can be carried out under neutral conditions and the whole process is pollution-free and environmentally friendly.

The disclosed compositions are more fully described in the Examples and Claims that follow herein.

### C. Methods of Making the Disclosed Compositions

The disclosed compositions can be obtained by the methods of the present disclosure. The disclosed methods provide the following technical solution to obtain the disclosed compositions: method of using polymer modified-Li/Al-LDH to enhance the lithium extraction performance, characterized in that two different modification methods, modification during precipitation reaction process or direct stirring and mixing, are used under different suitable conditions to obtain the disclosed composition. The adsorbent is applied to the lithium extraction from the shale gas produced water, and the extraction of lithium ions and the regeneration of the polymer modified-Li/Al-LDH material can be realized after the adsorption and desorption process.

Among them, modification during precipitation reaction process is as follows: (a) pumping a lithium and aluminum mixing salt solution, as well as the polymer solution into glass jacket reactor which contains alkali solution with high concentration; preferred pumping speed 5 mL/min˜10 mL/min. preferred polymer solution concentration 10%˜30%, wherein the pumping can be stopped when the slurry pH reaches 7.0. After that, using deionized water to wash the slurry; the volume amount of deionized water is 20˜80 mL/g, further preferably, 40 mL/g˜60 mL/g; (b) drying the slurry under high temperature for 24 hours; the temperature ≥normal temperature, further preferably, 50° C.˜80° C.; (c) grinding the powder cake using agate mortar and store the product in dry conditions.

In a further aspect, the disclosed method for obtaining the disclosed compositions comprises: (a) pumping lithium and aluminum salt solution and a polymer solution into glass jacket reactor which contains alkali solution with high concentration, and cease pumping the into the container when the slurry comprising the polymer solution and the Li/Al-LDH salt solution has a pH of about 7.0; (b) washing the slurry with deionized water wherein the volume of deionized water is 20˜80 mL/g, further preferably, 40 mL/g˜60 mL/g; and (c) drying the slurry under high temperature, wherein the high temperature is about 50° C. to about 80° C. The method can further comprise grinding the dried slurry.

In a further aspect, the disclosed method for obtaining the disclosed compositions comprises: (a) mixing a Li/Al-LDH powder and polymer solution with continuous stirring, wherein the mixing is carried out at a temperature of about 20° C. to about 100° C., further preferably, 20° C.˜60° C. The concentration of polymer solution is 10%˜30%; and (b) drying the slurry at a temperature less than about 60° C.; and (c) grinding the dried slurry powder.

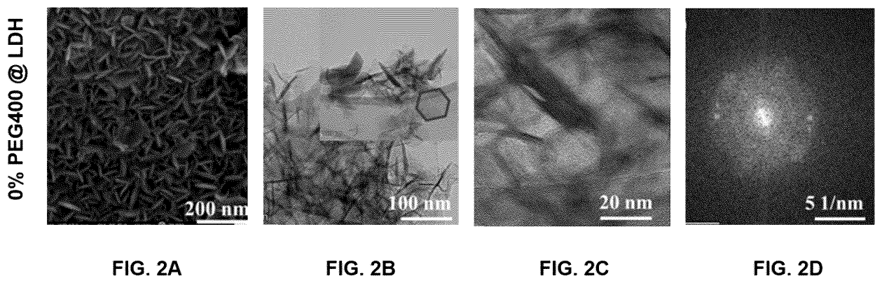

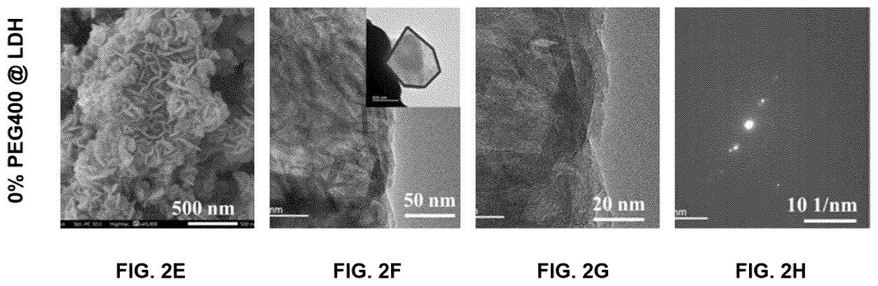

The obtained disclosed composition, i.e., a polymer modified-LDH, can be used for lithium adsorption and desorption treatment, e.g., using representative process shown in FIG. 2.

The present disclosure, without wishing to be bound by a particular theory, can be further understood explained below: (a) after modification, the polymer long chains are believed to be irregularly lamellar bound and may be inserted between layers or throughout the laminate, leading to modifications in the original physical and chemical properties; (b) lithium ions are believed to be bindable within the Al—O cavities of the lamellae in a directional manner, facilitating highly selective capture; (c) intercalated-Li⁺ can be de-intercalated under certain suitable conditions and released into the environment to realize the lithium extraction; and (d) the structural stability of the polymer modified-LDH material can be ensured, remaining intact and unbroken throughout the process.

The disclosed methods can be further understood in view of the Examples and claims as disclosed herein below.

### D. References

References are cited herein throughout using the format of reference number(s) enclosed by parentheses corresponding to one or more of the following numbered references. For example, citation of references numbers 1 and 2 immediately herein below would be indicated in the disclosure as (Refs. 1 and 2).
[Ref. 1] Choubey, P. K.; Kim, M.-s.; Srivastava, R. R.; Lee, J.-c.; Lee, J.-Y., Advance review on the exploitation of the prominent energy-storage element: Lithium. Part I: From mineral and brine resources. Minerals Engineering 2016, 89, 119-137.
[Ref. 2] Zhu, S.-g.; He, W.-z.; Li, G.-m.; Zhou, X.; Zhang, X.-j.; Huang, J.-w., Recovery of Co and Li from spent lithium-ion batteries by combination method of acid leaching and chemical precipitation. Transactions of Nonferrous Metals Society of China 2012, 22 (9), 2274-2281.
[Ref. 3] Zhang, Y.; Wang, W.; Fang, Q.; Xu, S., Improved recovery of valuable metals from spent lithium-ion batteries by efficient reduction roasting and facile acid leaching. Waste Manag 2020, 102, 847-855.
[Ref. 4] Tao, R.; Xing, P.; Li, H.; Sun, Z.; Wu, Y., Recovery of spent LiCoO2 lithium-ion battery via environmentally friendly pyrolysis and hydrometallurgical leaching. Resources, Conservation and Recycling 2022, 176, 105921.
[Ref. 5] Zhou, F.; Li, X.; Wang, S.; Qu, X.; Zhao, J.; Wang, D.; Chen, Z.; Yin, H., Recovery of valuable metals from spent lithium-ion batteries through biomass pyrolysis gas-induced reduction. J Hazard Mater 2023, 459, 132150.
[Ref. 6] Liang, Z.; Cai, C.; Peng, G.; Hu, J.; Hou, H.; Liu, B.; Liang, S.; Xiao, K.; Yuan, S.; Yang, J., Hydrometallurgical Recovery of Spent Lithium Ion Batteries: Environmental Strategies and Sustainability Evaluation. ACS Sustainable Chemistry & Engineering 2021, 9 (17), 5750-5767.
[Ref. 7] Liu, C.; Lin, J.; Cao, H.; Zhang, Y.; Sun, Z., Recycling of spent lithium-ion batteries in view of lithium recovery: A critical review. Journal of Cleaner Production 2019, 228, 801-813.
[Ref. 8] Kumar, J.; Neiber, R. R.; Park, J.; Ali Soomro, R.; Greene, G. W.; Ali Mazari, S.; Young Seo, H.; Hong Lee, J.; Shon, M.; Wook Chang, D.; Yong Cho, K., Recent progress in sustainable recycling of LiFePO4-type lithium-ion batteries: Strategies for highly selective lithium recovery. Chemical Engineering Journal 2022, 431, 133993.
[Ref. 9] Jang, E.; Jang, Y.; Chung, E., Lithium recovery from shale gas produced water using solvent extraction. Applied Geochemistry 2017, 78, 343-350.
[Ref. 10] Liu, Q.; Yang, P.; Tu, W.; Sun, H.; Li, S.; Zhang, Y., Lithium recovery from oil and gas produced water: Opportunities, challenges, and future outlook. Journal of Water Process Engineering 2023, 55, 104148.
[Ref. 11] Jang, Y.; Chung, E., Lithium adsorptive properties of H(2)TiO(3) adsorbent from shale gas produced water containing organic compounds. Chemosphere 2019, 221, 75-80.
[Ref. 12] Tian, L.; Liu, Y.; Tang, P.; Yang, Y.; Wang, X.; Chen, T.; Bai, Y.; Tiraferri, A.; Liu, B., Lithium extraction from shale gas flowback and produced water using H1.33Mn1.67O4 adsorbent. Resources, Conservation and Recycling 2022, 185.
[Ref. 13] Paranthaman, M. P.; Li, L.; Luo, J.; Hoke, T.; Ucar, H.; Moyer, B. A.; Harrison, S., Recovery of Lithium from Geothermal Brine with Lithium-Aluminum Layered Double Hydroxide Chloride Sorbents. Environ Sci Technol 2017, 51 (22), 13481-13486.
[Ref. 14] Zhang, L.; Zhang, T.; Zhao, Y.; Dong, G.; Lv, S.; Ma, S.; Song, S.; Quintana, M., Doping engineering of lithium-aluminum layered double hydroxides for high-efficiency lithium extraction from salt lake brines. Nano Research 2023, 17 (3), 1646-1654.
[Ref. 15] Chen, J.; Lian, C.; Yu, J.; Lin, S., A directional growth strategy for high layer charge Li/Al-LDHs to reinforce Li+ extraction in low-grade salt lake brines. AlChE Journal 2023, 70 (2).
[Ref. 16] Dong, M.; Luo, Q.; Li, J.; Shi, K.; Wu, Z.; Tang, J., Reconstruction of MgAl-layered double hydroxides to LiAl-layered double hydroxides for scalable lithium extraction from salt lake brine. Minerals Engineering 2023, 202, 108293.
[Ref. 17] Chen, J.; Lin, S.; Yu, J., High-selective cyclic adsorption and magnetic recovery performance of magnetic lithium-aluminum layered double hydroxides (MLDHs) in extracting Li+ from ultrahigh Mg/Li ratio brines. Separation and Purification Technology 2021, 255.
[Ref. 18] Chen, J.; Du, J.; Yu, J.; Lin, S., A one-step regeneration method in-situ for deactivated aluminum-based lithium adsorbent used in high Mg2+/Li+ brines. Desalination 2023, 554, 116491.
[Ref. 19] Lee, J. T.; Wyatt, B. C.; Davis, G. A., Jr.; Masterson, A. N.; Pagan, A. L.; Shah, A.; Anasori, B.; Sardar, R., Covalent Surface Modification of Ti(3)C(2)T(x) MXene with Chemically Active Polymeric Ligands Producing Highly Conductive and Ordered Microstructure Films. ACS Nano 2021, 15 (12), 19600-19612.
[Ref. 20] Lei, Q.-K.; Zhang, Q.; Wu, X.-Y.; Wei, X.; Zhang, J.; Wang, K.-X.; Chen, J.-S., Towards ultra-stable lithium metal batteries: Interfacial ionic flux regulated through LiAl LDH-modified polypropylene separator. Chemical Engineering Journal 2020, 395.
[Ref. 21] Lv, S.; Zhao, Y.; Zhang, L.; Zhang, T.; Dong, G.; Li, D.; Cheng, S.; Ma, S.; Song, S.; Quintana, M., Anion regulation strategy of lithium-aluminum layered double hydroxides for strengthening resistance to deactivation in lithium recovery from brines. Chemical Engineering Journal 2023, 472.
[Ref. 22] Li, Y.; Tang, N.; Zhang, L.; Li, J., Fabrication of Fe-doped lithium-aluminum-layered hydroxide chloride with enhanced reusable stability inspired by computational theory and its application in lithium extraction. Colloids and Surfaces A: Physicochemical and Engineering Aspects 2023, 658.
[Ref. 23] Chen, J.; Yuan, H.; Yu, J.; Yan, M.; Yang, Y.; Lin, S., Regulating lithium extraction based on intercalated SO(4)(2-) in Li/Al-LDHs. J Colloid Interface Sci 2023, 649, 694-702.
[Ref. 24] Hu, X.; Zhu, Q.; Gu, Z.; Zhang, N.; Liu, N.; Stanislaus, M. S.; Li, D.; Yang, Y., Wastewater treatment by sonophotocatalysis using PEG modified TiO2 film in a circular Photocatalytic-Ultrasonic system. Ultrasonics Sonochemistry 2017, 36, 301-308.
[Ref. 25] Khoerunnisa, F.; Rahmah, W.; Seng Ooi, B.; Dwihermiati, E.; Nashrah, N.; Fatimah, S.; Ko, Y. G.; Ng, E.-P., Chitosan/PEG/MWCNT/Iodine composite membrane with enhanced antibacterial properties for dye wastewater treatment. Journal of Environmental Chemical Engineering 2020, 8 (2), 103686.
[Ref. 26] Luo, H.; Zeng, X.; Liao, P.; Rong, H.; Zhang, T. C.; Jason Zhang, Z.; Meng, X., Phosphorus removal and recovery from water with macroporous bead adsorbent constituted of alginate-Zr4+ and PNIPAM-interpenetrated networks. International Journal of Biological Macromolecules 2019, 126, 1133-1144.
[Ref. 27] Mandal, S.; Kalaivanan, S.; Mandal, A. B., Polyethylene Glycol-Modified Layered Double Hydroxides: Synthesis, Characterization, and Study on Adsorption Characteristics for Removal of Acid Orange II from Aqueous Solution. ACS Omega 2019, 4 (2), 3745-3754.
[Ref. 28] Pan, Y.; Yu, J.; Lin, S., A rational strategy for synchronous extraction of lithium and boron from salt lake brines. Chemical Engineering Science 2023.
[Ref. 29] Blochl, P. E., Projector augmented-wave method. Phys Rev B Condens Matter 1994, 50 (24), 17953-17979.
[Ref. 30] Wang, H.; Han, H.; Yin, G.; Wang, C. Y.; Hou, Y. Y.; Tang, J.; Dai, J. X.; Ren, C. L.; Zhang, W.; Huai, P., First-Principles Study of Vacancies in Ti(3)SiC(2) and Ti(3)AlC(2). Materials (Basel) 2017, 10 (2).
[Ref. 31] Grimme, S., Semiempirical GGA-type density functional constructed with a long-range dispersion correction. J Comput Chem 2006, 27 (15), 1787-99.
[Ref. 32] Guazzelli, E.; Galli, G.; Martinelli, E., The Effect of Poly(ethylene glycol) (PEG) Length on the Wettability and Surface Chemistry of PEG-Fluoroalkyl-Modified Polystyrene Diblock Copolymers and Their Two-Layer Films with Elastomer Matrix. Polymers (Basel) 2020, 12 (6).
[Ref. 33] Kiss, E.; Kutnyanszky, E.; Bertoti, I., Modification of poly(lactic/glycolic acid) surface by chemical attachment of poly(ethylene glycol). Langmuir 2010, 26 (3), 1440-4.
[Ref. 34] Xiao, K.; Li, Y.; Luo, J.; Lee, J. S.; Xiao, W.; Gonik, A. M.; Agarwal, R. G.; Lam, K. S., The effect of surface charge on in vivo biodistribution of PEG-oligocholic acid based micellar nanoparticles. Biomaterials 2011, 32 (13), 3435-46.
[Ref. 35] Hess, F.; Kipping, T.; Weitschies, W.; Krause, J. Understanding the Interaction of Thermal, Rheological, and Mechanical Parameters Critical for the Processability of Polyvinyl Alcohol-Based Systems during Hot Melt Extrusion Pharmaceutics [Online], 2024.
[Ref. 36] Zhong, J.; Lin, S.; Yu, J., Lithium recovery from ultrahigh Mg2+/Li+ ratio brine using a novel granulated Li/Al-LDHs adsorbent. Separation and Purification Technology 2021, 256.
[Ref. 37] Tian, Y.; Wu, J., A comprehensive analysis of the BET area for nanoporous materials. AlChE Journal 2017, 64 (1), 286-293.
[Ref. 38] Khairuddin; Pramono, E.; Utomo, S. B.; Wulandari, V.; Zahrotul W, A.; Clegg, F., The effect of polyethylene glycol Mw 400 and 600 on stability of Shellac Waxfree. Journal of Physics: Conference Series 2016, 776 (1), 012054.
[Ref. 39] Sun, Y.; Yun, R.; Zang, Y.; Pu, M.; Xiang, X., Highly Efficient Lithium Recovery from Pre-Synthesized Chlorine-Ion-Intercalated LiAl-Layered Double Hydroxides via a Mild Solution Chemistry Process. Materials (Basel) 2019, 12 (12).
[Ref. 40] Jia, Y.; Fang, Y.; Zhang, Y.; Miras, H. N.; Song, Y. F., Classical Keggin Intercalated into Layered Double Hydroxides: Facile Preparation and Catalytic Efficiency in Knoevenagel Condensation Reactions. Chemistry 2015, 21 (42), 14862-70.
[Ref. 41] Pan, Y.; Yin, S.; Yu, J.; Lin, S., Efficient Step-by-Step Desorption to Reduce Boron in Brine Lithium Extraction. Industrial & Engineering Chemistry Research 2023.
[Ref. 42] Zhang, X.; Fu, C.; Feng, L.; Ji, Y.; Tao, L.; Huang, Q.; Li, S.; Wei, Y., PEGylation and polyPEGylation of nanodiamond. Polymer 2012, 53 (15), 3178-3184.
[Ref. 43] Sant, S.; Poulin, S.; Hildgen, P., Effect of polymer architecture on surface properties, plasma protein adsorption, and cellular interactions of pegylated nanoparticles. J Biomed Mater Res A 2008, 87 (4), 885-95.
[Ref. 44] Tian, L.; Ma, W.; Han, M., Adsorption behavior of Li+ onto nano-lithium ion sieve from hybrid magnesium/lithium manganese oxide. Chemical Engineering Journal 2010, 156 (1), 134-140.
[Ref. 45] Vigdorowitsch, M.; Pchelintsev, A.; Tsygankova, L.; Tanygina, E., Freundlich Isotherm: An Adsorption Model Complete Framework. Applied Sciences 2021, 11 (17).
[Ref. 46] Serban, A.; García-Fernández, J.; Gheorghe, D.; Sandu, R.; Neacsu, A.; Neacsu, D.-A.; Botea-Petcu, A.; Díez Villares, S.; Teodorescu, F.; Tudor Popa, V.; de la Fuente Freire, M.; Tanasescu, S., Aptamer functionalization effect on the interaction of sphingomyelin nanoemulsions with plasma proteins. A thermodynamic approach. Journal of Molecular Liquids 2024, 397, 124032.
[Ref. 47] Li, Y. H.; Di, Z.; Ding, J.; Wu, D.; Luan, Z.; Zhu, Y., Adsorption thermodynamic, kinetic and desorption studies of Pb2+ on carbon nanotubes. Water Res 2005, 39 (4), 605-9.
[Ref. 48] Ji, H.; Wu, W.; Li, F.; Yu, X.; Fu, J.; Jia, L., Enhanced adsorption of bromate from aqueous solutions on ordered mesoporous Mg—Al layered double hydroxides (LDHs). J Hazard Mater 2017, 334, 212-222.
[Ref. 49] Lin, M.-C.; Chang, F.-T.; Uan, J.-Y., Synthesis of Li—Al-carbonate layered double hydroxide in a metal salt-free system. Journal of Materials Chemistry 2010, 20 (31).
[Ref. 50] Wahib, S. A.; Da'na, D. A.; Zaouri, N.; Hiji, Y. M.; Al-Ghouti, M. A., Adsorption and recovery of lithium ions from groundwater using date pits impregnated with cellulose nanocrystals and ionic liquid. J Hazard Mater 2022, 421, 126657.
[Ref. 51] Cao, Z.; Adnan, N. N. M.; Wang, G.; Rawal, A.; Shi, B.; Liu, R.; Liang, K.; Zhao, L.; Gooding, J. J.; Boyer, C.; Gu, Z., Enhanced colloidal stability and protein resistance of layered double hydroxide nanoparticles with phosphonic acid-terminated PEG coating for drug delivery. J Colloid Interface Sci 2018, 521, 242-251.
[Ref. 52] Wang, C.; Huang, Y.; Li, J.; Wang, M.; Du, X.; Chen, D., Preparation of superhydrophobic Li—Al-Ala LDH/SA film with enhanced corrosion resistance and mechanical stability on AZ91D Mg alloy. Journal of Materials Science 2022, 57 (31), 14780-14798.
[Ref. 53] Li, M.-H.; Zhao, L.-X.; Xie, M.; Li, N.; Wang, X.-L.; Zhao, R.-S.; Lin, J.-M., Singlet oxygen-oriented degradation of sulfamethoxazole by Li—Al LDH activated peroxymonosulfate. Separation and Purification Technology 2022, 290.
[Ref. 54] Lang J., Jin Y., Liu K. et al. High-purity electrolytic lithium obtained from low-purity sources using solid electrolyte[J]. Nature Sustainability, 2020, 3(5): 386-390.
[Ref. 55] Zhang W., Koverga V., Liu S. et al. Single-phase local-high-concentration solid polymer electrolytes for lithium-metal batteries[J]. Nature Energy, 2024, 10.1038/s41560-023-01443-0:
[Ref. 56] Zhang S., Wei X., Cao X. et al. Solar-driven membrane separation for direct lithium extraction from artificial salt-lake brine[J]. Nature Communications, 2024, 15(1): 238.
[Ref. 57] Zhang W., Sayavong P., Xiao X. et al. Recovery of isolated lithium through discharged state calendar ageing[J]. Nature, 2024, 626 (7998): 306-312.
[Ref. 58] Zhao X. X., Wang X. T., Guo J. Z. et al. Dynamic Li(+) Capture through Ligand-Chain Interaction for the Regeneration of Depleted LiFePO(4) Cathode[J]. Adv Mater, 2024, 10.1002/adma.202308927: e2308927.
[Ref. 59] Zeng Y., Li W., Wan Z. et al. Electrochemically Mediated Lithium Extraction for Energy and Environmental Sustainability[J]. Advanced Functional Materials, 2024, 10.1002/adfm.202400416:
[Ref. 60] Pan Y., Du J., Chen J. et al. Interlayer intercalation of Li/Al-LDHs responsible for high-efficiency boron extraction[J]. Desalination, 2022, 539:
[Ref. 61] Choe G., Kim H., Kwon J. et al. Re-evaluation of battery-grade lithium purity toward sustainable batteries[J]. Nature Communications, 2024, 15(1): 1185.
[Ref. 62] Kumar A., Fukuda H., Hatton T. A., Lienhard J. H. Lithium Recovery from Oil and Gas Produced Water: A Need for a Growing Energy Industry[J]. ACS Energy Letters, 2019, 4 (6): 1471-1474.
[Ref. 63] Liu Q., Yang P., Tu W. et al. Lithium recovery from oil and gas produced water: Opportunities, challenges, and future outlook[J]. Journal of Water Process Engineering, 2023, 55:104148.
[Ref. 64] Zhang Y., Sun W., Xu R. et al. Lithium extraction from water lithium resources through green electrochemical-battery approaches: A comprehensive review[J]. Journal of Cleaner Production, 2021, 285:124905.
[Ref. 65] Sun Y., Wang Q., Wang Y. et al. Recent advances in magnesium/lithium separation and lithium extraction technologies from salt lake brine[J]. Separation and Purification Technology, 2021, 256:
[Ref. 66] Li X., Mo Y., Qing W. et al. Membrane-based technologies for lithium recovery from water lithium resources: A review[J]. Journal of Membrane Science, 2019, 591:117317.
[Ref. 67] Farahbakhsh J., Arshadi F., Mofidi Z. et al. Direct lithium extraction: A new paradigm for lithium production and resource utilization[J]. Desalination, 2024, 575:117249.
[Ref. 68] Chen J., Huang K., Du J. et al. Why is aluminum-based lithium adsorbent ineffective in Li+ extraction from sulfate-type brines[J]. AlChE Journal, 2023, 69 (10):
[Ref. 69] Yi H., Liu S., Lai C. et al. Recent Advance of Transition-Metal-Based Layered Double Hydroxide Nanosheets: Synthesis, Properties, Modification, and Electrocatalytic Applications[J]. Advanced Energy Materials, 2021, 11(14):
[Ref. 70] Fang Q., Ye S., Yang H. et al. Application of layered double hydroxide-biochar composites in wastewater treatment: Recent trends, modification strategies, and outlook[J]. Journal of Hazardous Materials, 2021, 420:126569.
[Ref. 71] Wilson O. C., Olorunyolemi T., Jaworski A. et al. Surface and interfacial properties of polymer-intercalated layered double hydroxide nanocomposites[J]. Applied Clay Science, 1999, 15(1): 265-279.
[Ref. 72] Deng S., Ting Y. P. Fungal Biomass with Grafted Poly(acrylic acid) for Enhancement of Cu(II) and Cd(II) Biosorption[J]. Langmuir, 2005, 21(13): 5940-5948.
[Ref. 73] Zeng G., Liu Y., Tang L. et al. Enhancement of Cd(II) adsorption by polyacrylic acid modified magnetic mesoporous carbon[J]. Chemical Engineering Journal, 2015, 259:153-160.
[Ref. 74] Bibi A., Bibi S., Abu-Dieyeh M., Al-Ghouti M. A. New material of polyacrylic acid-modified graphene oxide composite for phenol remediation from synthetic and real wastewater[J]. Environmental Technology & Innovation, 2022, 27:102795.
[Ref. 75] G. Kresse av J. F. Efficiency of ab-initio total energy calculations for metals and semiconductors using a plane-wave basis set[J]. Computational Materials Science, 1996, 6 (1): 15-50.
[Ref. 76] Blochl P. E. Projector augmented-wave method[J]. Phys Rev B Condens Matter, 1994, 50 (24): 17953-17979.
[Ref. 77] J. P. Perdew K. B., M. Ernzerhof. Generalized gradient approximation made simple[J]. Rev. Lett., 1996, 77(18): 3865-3868.
[Ref. 78] Grimme S. Semiempirical GGA-type density functional constructed with a long-range dispersion correction[J]. J Comput Chem, 2006, 27 (15): 1787-1799.
[Ref. 79] Sarti F., Müller C., Iqbal J. et al. Development and in vivo evaluation of an oral vitamin B12 delivery system[J]. European Journal of Pharmaceutics and Biopharmaceutics, 2013, 84 (1): 132-137.
[Ref. 80] Leroux F., Besse J.-P. Polymer Interleaved Layered Double Hydroxide: A New Emerging Class of Nanocomposites[J]. Chemistry of Materials, 2001, 13 (10): 3507-3515.
[Ref. 81] Omidi M. H., Azqhandi M. H. A., Ghalami-Choobar B. Synthesis, characterization, and application of graphene oxide/layered double hydroxide/poly acrylic acid nanocomposite (LDH-rGO-PAA NC) for tetracycline removal: A comprehensive chemometric study[J]. Chemosphere, 2022, 308:136007.
[Ref. 82] Zhou Y., Li X., Wang K. et al. Enhanced photoluminescence emission and surface fluorescence response of morphology controllable nano porous anodize alumina Zn—Al LDH film[J]. Journal of Alloys and Compounds, 2019, 770:6-16.
[Ref. 83] Chen J., Lian C., Yu J., Lin S. A directional growth strategy for high layer charge Li/Al-LDHs to reinforce Li+ extraction in low-grade salt lake brines[J]. AlChE Journal, 2023, 70 (2):
[Ref. 84] Xu J., Wei X., Han J., Qin W. Synthesis and optimisation mechanism of functionalised adsorption materials for lithium-ion extraction from salt water: A review[J]. Separation and Purification Technology, 2024, 339:126237.
[Ref. 85] Guo Y., Yu J., Su H., Lin S. Desorption enhancement of aluminum-based adsorbent in lithium extraction from sulfate-type salt lakes[J]. Desalination, 2024, 571:
[Ref. 86] Rekha Sahoo D., Biswal T. A comparative study of the drug delivery behaviour of poly acrylic acid (PAA) reinforced with chitosan, guargum and pectin[J]. Materials Today: Proceedings, 2024, 10.1016/j.matpr.2024.02.005:
[Ref. 87] Zhang J., Azam M. S., Shi C. et al. Poly(acrylic acid) functionalized magnetic graphene oxide nanocomposite for removal of methylene blue[J]. RSC Advances, 2015, 5(41): 32272-32282.
[Ref. 88] Li C.-C., Chang S.-J., Su F.-J. et al. Effects of capping agents on the dispersion of silver nanoparticles[J]. Colloids and Surfaces A: Physicochemical and Engineering Aspects, 2013, 419:209-215.
[Ref. 89] Liufu S., Xiao H., Li Y. Adsorption of poly(acrylic acid) onto the surface of titanium dioxide and the colloidal stability of aqueous suspension[J]. J Colloid Interface Sci, 2005, 281 (1): 155-163.
[Ref. 90] Wei Z., Vandergriff A., Liu C. H. et al. Strongly coupled plasmonic metal nanoparticles with reversible pH-responsiveness and highly reproducible SERS in solution[J]. Nanoscale, 2024, 16 (2): 708-718.
[Ref. 91] Ivanets A. I., Prozorovich V. G., Kouznetsova T. F. et al. Sorption behavior of 85Sr onto manganese oxides with tunnel structure[J]. Journal of Radioanalytical and Nuclear Chemistry, 2018, 316 (2): 673-683.
[Ref. 92] Tao L., Shi Y., Huang Y.-C. et al. Interface engineering of Pt and CeO2 nanorods with unique interaction for methanol oxidation[J]. Nano Energy, 2018, 53:604-612.
[Ref. 93] Khoddam Z., Pourmadadi M., Abdouss M. et al. Hybrid nanocarriers based on polyacrylic acid, polyvinyl pyrrolidone, and molybdenum disulfide for enhanced 5-fluorouracil delivery in lung cancer therapy[J]. Inorganic Chemistry Communications, 2024, 159:
[Ref. 94] Long X., Liu C., Yang Y. et al. Microwave-assisted hydrothermal synthesis of lithium ion-sieve for adsorption of lithium ion in coal gangue leaching solution[J]. Colloids and Surfaces A: Physicochemical and Engineering Aspects, 2024, 682:
[Ref. 95] Liu L., Kuang Q., Xu S. et al. Enhanced lithium-ion adsorption by recyclable lithium manganese oxide-sepiolite composite microsphere from aqueous media: Fabrication, structure, and adsorption characteristics[J]. Journal of Molecular Liquids, 2023, 380:121780.
[Ref. 96] Huangfu C., Yu S., Tong B. et al. Efficient lithium extraction from aqueous solutions by MIL-100 (Fe): A study on adsorption kinetics, thermodynamics and mechanism[J]. Separation and Purification Technology, 2023, 322:
[Ref. 97] Zhong J., Lin S., Yu J. Lithium recovery from ultrahigh Mg2+/Li+ ratio brine using a novel granulated Li/Al-LDHs adsorbent[J]. Separation and Purification Technology, 2021, 256:
[Ref. 98] Wei S., Wei Y., Chen T. et al. Porous lithium ion sieves nanofibers: General synthesis strategy and highly selective recovery of lithium from brine water[J]. Chemical Engineering Journal, 2020, 379:
[Ref. 99] Hu F., Lin S., Li P., Yu J. Quantitative Effects of Desorption Intensity on Structural Stability and Readsorption Performance of Lithium/Aluminum Layered Double Hydroxides in Cyclic Li+ Extraction from Brines with Ultrahigh Mg/Li Ratio[J]. Industrial & Engineering Chemistry Research, 2020, 59 (30): 13539-13548.
[Ref. 100] Pan Y., Yin S., Yu J., Lin S. Efficient Step-by-Step Desorption to Reduce Boron in Brine Lithium Extraction[J]. Industrial & Engineering Chemistry Research, 2023, 10.1021/acs.iecr.3c03081:
[Ref. 101] Pan Y., Yu J., Lin S. A rational strategy for synchronous extraction of lithium and boron from salt lake brines[J]. Chemical Engineering Science, 2023, 10.1016/j.ces.2023.118757:

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### E. Aspects

The present disclosure can be described in accordance with the following numbered aspects, which should not be confused with the claims.

Aspect 1. A composition comprising:
a Li/Al-LDH substrate; and
a polymer attached to the Li/Al-LDH substrate;
wherein the composition has improved affinity for extraction of lithium from a lithium-containing source material.

Aspect 2. The composition in aspect 1, wherein the polymer is selected from a polyethylene glycol (PEG), a polyacrylic acid (PAA), a polyacrylonitrile (PAN), a polylactic acid (PLA), a polyvinyl chloride (PVC), a polypropylene (PP), a poly(ethylene terephthalate) (PET), a polystyrene (PS), and combinations thereof.

Aspect 3. The composition in aspect 2, wherein the polymer is selected from polyethylene glycol (PEG), polyacrylic acid (PAA), polyacrylonitrile (PAN), and combinations thereof.

Aspect 4. The composition in aspect 2, wherein the polymer is polyethylene glycol.

Aspect 5. The composition in aspect 2, wherein the polymer is polyacrylic acid.

Aspect 6. The composition in aspect 2, wherein the polymer is polystyrene sulfonate.

Aspect 7. The composition in aspect 2, wherein the polymer in the polymer solution is polyvinyl sulfonate.

Aspect 8. The composition in aspect 2, wherein the polymer in the polymer solution is polylactic acid.

Aspect 9. The composition in aspect 2, wherein the polymer in the polymer solution is polyvinyl chloride.

Aspect 10. The composition in aspect 2, wherein the polymer in the polymer solution is polypropylene.

Aspect 11. The composition in aspect 2, wherein the polymer in the polymer solution is poly(ethylene terephthalate).

Aspect 12. The composition in aspect 2, wherein the polymer in the polymer solution is polystyrene.

Aspect 13. The composition of any one of aspects 1-13, wherein the polymer has a weight average molecular weight (Mw) less than about 10,000 Da.

Aspect 14. The composition of aspect 13, wherein the polymer has a molecular weight from about 100 Da to about 10,000 Da.

Aspect 15. The composition of aspect 13, wherein the polymer has a molecular weight from about 500 Da to about 10,000 Da.

Aspect 16. The composition of aspect 13, wherein the polymer has a molecular weight from about 1,000 Da to about 10,000 Da.

Aspect 17. The composition of aspect 13, wherein the polymer has a molecular weight from about 2,500 Da to about 10,000 Da.

Aspect 18. The composition of aspect 13, wherein the polymer has a molecular weight from about 5,000 Da to about 10,000 Da.

Aspect 19. The composition of aspect 13, wherein the polymer has a molecular weight from about 7,500 Da to about 10,000 Da.

Aspect 20. The composition of aspect 13, wherein the polymer has a molecular weight from about 100 Da to about 9,000 Da.

Aspect 21. The composition of aspect 13, wherein the polymer has a molecular weight from about 100 Da to about 9,000 Da.

Aspect 22. The composition of aspect 13, wherein the polymer has a molecular weight from about 100 Da to about 7,500 Da.

Aspect 23. The composition of aspect 13, wherein the polymer has a molecular weight from about 100 Da to about 5,000 Da.

Aspect 24. The composition of aspect 13, wherein the polymer has a molecular weight from about 100 Da to about 2,500 Da.

Aspect 25. The composition of aspect 13, wherein the polymer has a molecular weight from about 100 Da to about 1,000 Da.

Aspect 26. The composition of aspect 13, wherein the polymer has a molecular weight from about 100 Da to about 500 Da.

Aspect 27. The composition of any one of aspects 1-26, wherein the polymer is a block copolymer comprising two or more blocks; and wherein each block is independently selected from a polymer block comprising a polyethylene glycol (PEG), a polyacrylic acid (PAA), a polyacrylonitrile (PAN), a polylactic acid (PLA), a polyvinyl chloride (PVC), a polypropylene (PP), a poly(ethylene terephthalate) (PET), a polystyrene (PS), and combinations thereof.

Aspect 28. The composition in aspect 27, wherein the polymer a polymer is selected from polyethylene glycol (PEG), polyacrylic acid (PAA), polyacrylonitrile (PAN), and combinations thereof.

Aspect 29. The composition of aspect 26 or aspect 27, wherein the polymer comprises a first polymer block and a second polymer block.

Aspect 30. The composition of aspect 29, wherein the first polymer block and the second polymer block each comprise different polymer blocks.

Aspect 31. The composition of any one of aspects 1-26, wherein the polymer is a gradient copolymer comprising; wherein the gradient on a gradient from a first gradient polymer comprising a polyethylene glycol (PEG), a polyacrylic acid (PAA), a polyacrylonitrile (PAN), a polylactic acid (PLA), a polyvinyl chloride (PVC), a polypropylene (PP), a poly (ethylene terephthalate) (PET), a polystyrene (PS), and combinations thereof, and a second gradient polymer comprising a polyethylene glycol (PEG), a polyacrylic acid (PAA), a polyacrylonitrile (PAN), a polylactic acid (PLA), a polyvinyl chloride (PVC), a polypropylene (PP), a poly (ethylene terephthalate) (PET), a polystyrene (PS), and combinations thereof; and wherein the gradient is a relatively higher concentration of the first gradient polymer at a first terminus of the gradient copolymer to a lower concentration of the first gradient polymer at a second terminus of the gradient polymer distal to the first terminus.

Aspect 32. The composition in aspect 27, wherein the polymer a polymer is selected from polyethylene glycol (PEG), polyacrylic acid (PAA), polyacrylonitrile (PAN), and combinations thereof.

Aspect 33. The composition of any one of aspects 1-32, wherein the weight ratio of the polymer to the Li/Al-LDH substrate is about 0.1:1 to about 100:1.

Aspect 34. The composition of aspect 33, wherein the weight ratio of the polymer to the Li/Al-LDH substrate is about 1:1 to about 50:1.

Aspect 35. The composition of aspect 33, wherein the weight ratio of the polymer to the Li/Al-LDH substrate is about 5:1 to about 50:1.

Aspect 36. The composition of aspect 33, wherein the weight ratio of the polymer to the Li/Al-LDH substrate is about 10:1 to about 50:1.

Aspect 37. The composition of aspect 33, wherein the weight ratio of the polymer to the Li/Al-LDH substrate is about 1:1 to about 30:1.

Aspect 38. The composition of aspect 33, wherein the weight ratio of the polymer to the Li/Al-LDH substrate is about 5:1 to about 30:1.

Aspect 39. The composition of aspect 33, wherein the weight ratio of the polymer to the Li/Al-LDH substrate is about 10:1 to about 30:1.

Aspect 40. The composition of aspect 33, wherein the weight ratio of the polymer to the Li/Al-LDH substrate is about 1:1 to about 20:1.

Aspect 41. The composition of aspect 33, wherein the weight ratio of the polymer to the Li/Al-LDH substrate is about 1:1 to about 10:1.

Aspect 42. A method for preparing a composition comprising a Li/Al-LDH substrate and a polymer, the method comprising the steps:
(a) providing a lithium and aluminum salt solution comprising the Li/Al-LDH substrate and a polymer solution comprising a polymer;
(b) pumping the lithium and aluminum salt solution and the polymer solution into an alkali solution within a container, thereby forming a slurry;
(c) allowing the lithium and aluminum salt solution and the polymer solution to be in contact with each other in the slurry at a temperature and for a time suitable for completion of formation of the composition comprising a Li/Al-LDH substrate and a polymer;
(d) washing the slurry with deionized water; and
(e) drying the slurry forming a powder product comprising the composition comprising a Li/Al-LDH substrate and a polymer;
thereby forming the composition comprising a Li/Al-LDH substrate and a polymer,
wherein the composition comprising a Li/Al-LDH substrate and a polymer comprises enhanced adsorption of lithium.

Aspect 43. The method in aspect 42, wherein the pumping is stopped once the slurry reaches a pH of about 7.0.

Aspect 44. The method in aspect 42 or aspect 43, wherein the alkali solution has a high concentration.

Aspect 45. The method any one of aspects 42-44, wherein the pumping speed of the polymer solution is between 2 mL/min and 20 mL/min.

Aspect 46. The method in aspect 45, wherein the pumping speed of the polymer solution is between 5 mL/min and 10 mL/min.

Aspect 47. The method any one of aspects 42-46, wherein the concentration of the polymer solution is between 5 wt/v % and 50 wt/v %.

Aspect 48. The method in aspect 47, wherein the concentration of the polymer solution is between 10 wt/v % and 30 wt/v %.

Aspect 49. The method any one of aspects 42-48, wherein the method takes place at a temperature between 30 degrees Celsius and 70 degrees Celsius.

Aspect 50. The method in aspect 49, wherein the method takes place at a temperature between 40 degrees Celsius and 60 degrees Celsius.

Aspect 51. The method any one of aspects 42-50, wherein after the drying, grinding is employed to achieve the powder product.

Aspect 52. The method any one of aspects 42-51, wherein the volume amount of deionized water used for washing is between 20 mL/g and 80 mL/g.

Aspect 53. The method in aspect 52, wherein the volume amount of deionized water used for washing is between 40 mL/g and 60 mL/g.

Aspect 54. The method any one of aspects 42-53, wherein the drying is carried out under a temperature of between 40 degrees Celsius and 90 degrees Celsius.

Aspect 55. The method in aspect 54, wherein drying is done under a temperature of between 50 degrees Celsius and 80 degrees Celsius.

Aspect 56. The method any one of aspects 42-55, wherein the drying is done for at least 24 hours.

Aspect 57. The method any one of aspects 42-56, wherein the container is glass jacket reactor.

Aspect 58. The method any one of aspects 42-50, wherein the polymer solution comprises a polymer selected from a polyethylene glycol (PEG), a polyacrylic acid (PAA), a polyacrylonitrile (PAN), a polylactic acid (PLA), a polyvinyl chloride (PVC), a polypropylene (PP), a poly (ethylene terephthalate) (PET), a polystyrene (PS), and combinations thereof.

Aspect 59. The method of aspect 58, wherein the polymer solution comprises a polymer selected from polyethylene glycol (PEG), polyacrylic acid (PAA), polyacrylonitrile (PAN), and combinations thereof.

Aspect 60. The method of aspect 58, wherein the polymer in the polymer solution is polyethylene glycol.

Aspect 61. The method of aspect 58, wherein the polymer in the polymer solution is polyacrylic acid.

Aspect 62. The method of aspect 58, wherein the polymer in the polymer solution is polyacrylonitrile.

Aspect 63. The method of aspect 58, wherein the polymer in the polymer solution is polystyrene sulfonate.

Aspect 64. The method of aspect 58, wherein the polymer in the polymer solution is polyvinyl sulfonate.

Aspect 65. The method of aspect 58, wherein the polymer in the polymer solution is polylactic acid.

Aspect 66. The method of aspect 58, wherein the polymer in the polymer solution is polyvinyl chloride.

Aspect 67. The method of aspect 58, wherein the polymer in the polymer solution is polypropylene.

Aspect 68. The method of aspect 58, wherein the polymer in the polymer solution is poly(ethylene terephthalate).

Aspect 69. The method of aspect 58, wherein the polymer in the polymer solution is polystyrene.

Aspect 70. The method any one of aspects 42-69, wherein the ratio of the polymer solution to Li/Al-LDH is 10 mL/g to 90 mL/g; and wherein the concentration of the polymer solution is between 5 wt/v % and 50 wt/v %.

Aspect 71. The method of aspect 70, wherein the concentration of the polymer solution is between 10 wt/v % and 30 wt/v %.

Aspect 72. The method of any one of aspects 42-71, wherein about 50% to about 100% of the polymer present initially in the polymer solution is incorporated into the composition comprising a Li/Al-LDH substrate obtained following step (e).

Aspect 73. A composition comprising a Li/Al-LDH substrate and a polymer made the method of any one of aspects 42-71.

Aspect 74. A method for the extraction of lithium, the method comprising:
(a) providing a lithium adsorbent composition; and
(b) contacting the disclosed lithium absorbent composition with a water-byproduct obtained from shale gas production;
wherein the disclosed lithium absorbent composition is the composition of any one of aspects 1-41 or the composition made by the method of any one of aspects 42-71 as a p a lithium adsorbent during a lithium adsorption process.

Aspect 75. The method of aspect 73, wherein the concentration of lithium in the polymer-modified Li/Al-LDH solution is between 100 mg/L and 200 mg/L.

Aspect 76. The method of aspect 73, wherein the liquid and solid ratio during the adsorption process is between 40 mL/g and 90 mL/g.

Aspect 77. The method of aspect 73, wherein the temperature during the lithium adsorption process is between 40 degrees Celsius and 60 degrees Celsius.

### F. Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### 1. Materials and Methods for Peg-Modified LDH

### 1.1 Materials

The chemicals employed for the synthesis of PEG-modified LDH (PEG@LDH), including PEG with an average molecular weight of 400 and 2000 (PEG400 and PEG 2000), lithium chloride (LiCl, ≥99 wt. % purity), aluminum chloride hexahydrate (AlCl₃·6H₂O, >99 wt. % purity), and sodium hydroxide (NaOH, ≥97 wt. % purity) were all purchased from Thermo Fisher Scientific, USA. Sodium chloride (NaCl, 99% wt. % purity), magnesium chloride (MgCl₂, 99 wt. % purity), and strontium chloride hexahydrate (SrCl₂·6H₂O, 99 wt. % purity) used for the preparation of synthetic brine were supplied by Sigma Aldrich, USA. Hydrochloric acid (HCl at 35-38 wt. %, ACS grade) and nitric acid (HNO₃ at 67-70 wt. %, trace metal grade), purchased from Thermo Fisher Scientific, USA, were used to adjust the solution pH and ICP test sample dilution, respectively. The Type I deionized water utilized in all experiments had a resistivity of 18.2 MΩ·cm at ambient temperature.

The elemental compositions and pH values of both synthetic and unconventional brines (shale gas produced water, collected from West Virginia, USA) are delineated in Table 1. To avoid the undesirable interference of organic constituents presenting in produced water, synthetic brine was utilized to optimize the preparation parameters during the synthesis of PEG@LDH. The adsorption/desorption performance of the unmodified and modified adsorbents was evaluated using the produced water. Prior to the tests, the produced water was filtered using filter papers with a pore size ranging from 10 to 15 microns to remove matter. Subsequently, the produced water underwent physical adsorption employing industrial grade activated carbon (Lab Alley, USA) to eliminate organic constituents.

TABLE 1
Elemental composition (mg/L) of different brines.

| Types | Li | Na | Mg | Ca | Sr | pH value |
|---|---|---|---|---|---|---|
| Unconventional | 74.6 | 41,882 | 1,915 | 23,332 | 34,412 | 2.31 |
| brine | | | | | | |
| Synthetic brine | 100 | 40,000 | 2,000 | 20,000 | 30,000 | 4.63 |

### 1.2 Synthesis of the PEG@LDH

The Li/Al-LDH was prepared through co-precipitation method. Typically, a mixed salt solution with predetermined concentrations of lithium and aluminum was gradually added dropwise to a glass-jacketed reactor containing water with high alkalinity. The precipitation reaction proceeded with stirring at 300 rpm, and the completion of the reaction was determined by monitoring the pH value to identify the reaction's end point. After a specified aging period of 60 min, the process of lithium-ion de-intercalation was carried out. The formation of the adsorbent powder was then achieved through filtration and drying.

PEG solutions of varied concentrations (0%, 5%, 10%, 25%, 40%, and 60% (w/v)) were prepared by dissolving certain amounts of PEG200 or PEG4000 into water followed by continuous stirring and ultrasonic treatment until achieving homogeneity. Subsequently, the adsorbent powder was mixed with the PEG solutions for roughly 2 hours at a specific PEG solution volume to powder mass (L/S) ratio and temperature to synthesize the desired products. The resulting mixture was then filtered, and the solid material was dried at 60° C. In the experiments investigating the effect of L/S ratio on the adsorbent performance, 10 mL/g, 20 mL/g, 40 mL/g, 60 mL/g, and 90 mL/g were investigated. The PEG@LDH formulations prepared using PEG400 and PEG2000 were designated as PEG400@LDH and PEG2000@LDH, respectively.

### 1.3 Lithium Adsorption and Desorption Experiments

During the lithium adsorption experiments using PEG@LDH, a liquid-solid ratio (L/S) of 60 mL/g was utilized, and the adsorption process took place in an orbital shaker (Model number 290400, Boekel Scientific, USA) at a rotational speed of 200 rpm for 2 hours at room temperature. Afterward, the mixture was subjected to liquid/solid separation using a centrifuge (Legend X1 Centrifuge, Thermo Scientific, USA) at 5000 rpm for 10 min. The resulting supernatant was diluted with 5% (v/v) HNO₃ solution. The lithium adsorption capacity (qₜ (mg/g)) was calculated by Eq. (1):

$${q}_{t} = V \cdot \frac{{c}_{0} - {c}_{t}}{m} \qquad Eq . ( 1 )$$

where m (g) is the mass of adsorbent used, V (L) is the volume of adsorbed solution, C₀ (mg/L) refers to the initial ion concentration in the solution, Cₜ (mg/L) refers to the ion concentration in the solution at time t (min).

The ability to separate adsorbed ions is a crucial metric for evaluating the efficacy of lithium adsorption, which is commonly expressed by the distribution factor K_{M} (mL/g) as given in Eq. (2):

$${K}_{M} = ( {C}_{0} - {C}_{t} ) \cdot V / ( {C}_{t} \cdot m ) \qquad Eq . ( 2 )$$

where m (g) means the mass of the adsorbent, V (mL) is the volume of the solution used. C₀ (mg/L) refers to the initial ion concentration, Cₜ (mg/L) is the ion concentration in the solution at time t (min).

To examine the impact of solution pH on lithium adsorption performance by PEG@LDH, the synthetic brine was adjusted to various pH values. Subsequently, shaking experiments were conducted at room temperature with an L/S of 60 mL/g for a duration of 2 hours. During the lithium kinetic experiments, L/S was fixed at 40 mL/g, 60 mL/g, and 80 mL/g, respectively, while maintaining other conditions constant. Samples were collected at various intervals for metal concentration analysis. Furthermore, various kinetic models were employed to characterize the adsorption process and reveal the adsorption mechanisms. Among these, the pseudo-first-order model was initially proposed to elucidate the adsorption process, as depicted in Eq. (3).

$$\frac{{dq}_{t}}{dt} = {k}_{1} \cdot ( {q}_{e 1} - {q}_{t} ) \qquad Eq . ( 3 )$$

where k₁ (1/min) is the rate constant of the model, qₑ₁ (mg/g) is the equilibrium adsorption amount, and qₜ (mg/g) is the adsorption amount at time t (min).

The pseudo-second-order model was a model that describes the process of interaction between a solid adsorbent and a solution system as well, and its form could be expressed as Eq. (4):

$$\frac{t}{{q}_{t}} = \frac{1}{{k}_{2} \cdot {q}_{e 2}^{2}} + \frac{1}{{q}_{e 2}} \cdot t \qquad Eq . ( 4 )$$

where k₂ (g/(mg·min)) is the rate constant of this model, qₑ₂ (mg/g) is the equilibrium adsorption amount, and qₜ (mg/g) is the adsorption amount at time t (min).

All isotherm adsorption experiments were carried out in a thermostatic water bath shaker set at 293 K, 313 K, and 333 K for 24 hours. The Freundlich (Eq. (5)) and Langmuir models (Eq. (6)) served as the analytical and fitting models, with their equations presented as follows:

$${Q}_{e 1} = {K}_{F} \cdot {C}_{e}^{1 / n} \qquad Eq . ( 5 )$$

$${Q}_{e 2} = \frac{{Q}_{m ax} \cdot b \cdot {C}_{e}}{1 + b \cdot {C}_{e}} \qquad Eq . ( 6 )$$

where Qₑ₁ (mg/g) and Qₑ₂ (mg/g) are the equilibrium adsorption capacity, Qₘₐₓ (mg/g) is the adsorption capacity per unit mass of adsorbent in a single layer, K_{F} is the Freundlich isotherm constant, which is usually related to adsorption. n is related to the adsorption intensity and homogeneity, b (L/mg) is the adsorption equilibrium constant of the Langmuir isotherm model. As the value b increases, the adsorption energy correspondingly escalates. Cₑ (mg/L) is the equilibrium concentration.

The assessment of the lithium desorption capacity involved an experimental setup that systematically varied the NaOH concentrations and initial Li⁺ levels in the desorbing solution, the liquid-to-solid (L/S) ratio of the desorbing solution to powder mass, and the desorption temperature. All batch experiments were conducted in a thermostatic water bath shaker operating at 250 rpm. The concentrations of NaOH were adjusted across a range from 0 mol/L to 0.1 mol/L, while Li⁺ concentrations were varied from 0 mg/L up to 200 mg/L. The L/S ratios were adjusted to 40 mL/g, 60 mL/g, and 80 mL/g, and temperatures were set at 293 K, 313 K, and 333 K. The desorption process was conducted for a total period of 60 min, and samples were extracted at various time intervals followed by solid-liquid separation and metal concentration analysis. The calculation of the lithium desorption amounts De (mg/g) followed Eq. (7).

$${D}_{e} = \frac{( {C}_{t} - {C}_{0} ) \cdot V}{m} \qquad Eq . ( 7 )$$

where Cₜ (mg/L) refers to the lithium concentration at time t, C₀ (mg/L) means the initial lithium concentration in the desorbing solution, V (L) is the volume of the used desorbing solution, m (g) refers to the powder mass.

Adsorption-desorption cycling experiments were meticulously performed to assess the recyclability of the synthesized materials. In the adsorption phase, a L/S ratio of 60 mL/g was sustained at room temperature, with the shaker set to 250 rpm for a period of 40 min. Subsequently, the desorption experiments were conducted over a duration of 30 min under neutral pH conditions at room temperature and 250 rpm. The cycling process was repeated eight times following the same procedures described above. All lithium adsorption and desorption experiments were conducted in triplicate to guarantee the study's precision and high repeatability.

### 1.4 Adsorption Thermodynamics

To investigate the energy transformations and thermodynamic characteristics associated with lithium adsorption, thermodynamic parameters such as Gibbs free energy (ΔG), enthalpy (ΔH) and entropy (ΔS) at three different temperatures (293 K, 313 K, 333 K) were calculated by using the following equations:

$$ln {K}_{d} = \frac{Δ S}{R} - \frac{Δ H}{R \cdot T} \qquad Eq . ( 8 )$$

$$Δ G = - R \cdot T \cdot ln {K}_{e} \qquad Eq . ( 9 )$$

where R (8.314 J/mol/K) refers to the universal gas factor, T (K) is the temperature in absolute scale, Kₑ (L/g) is the adsorption distribution co-efficient, and Kₑ=Qₑ/Cₑ. The change of ΔG at different temperatures was obtained by the Van't Hoff equation.

### 1.5 Characterizations

To elucidate the crystalline structure of the samples, wide-angle X-ray diffraction (XRD) analysis was conducted using a Bruker D8 instrument. The analysis was performed with Ni-filtered Cu-Kα radiation (λ=0.154 nm) generated at 40 kV and 40 mA, spanning the 2θ range from 5° to 80°, which facilitates a comprehensive assessment of the crystalline configurations. Microscopic morphology was captured using a scanning electron microscope (SEM, JEOL, Peabody, MA, USA), capable of operation at accelerating voltages ranging from 3.0 kV to 20.0 kV. The microstructure and crystal structure were analyzed using a high-resolution scanning transmission electron microscope (HRTEM, JEOL JEM 2100) outfitted with High-Angle Annular Dark Field (HAADF) imaging and operating with a 2 MV electron beam.

N₂ adsorption-desorption isotherms were obtained using an Autosob-1 surface analyzer manufactured by Quantachrome Instruments, USA. Samples were degassed under vacuum at 100° C. for 12 hours before measurements. The Brunauer-Emmett-Teller (BET) and Barrett-Joyner-Halenda (BJH) methods were employed for surface area and pore volume calculations, respectively. Fourier Transform Infrared Spectroscopy (FTIR) spectra were obtained using a Nicolet instrument (Nicolet Apex FTIR Spectrometer, Thermo Fisher Scientific, USA) with the samples being prepared as potassium bromide (KBr) pellets for the analysis.

X-ray Photoelectron Spectroscopy (XPS) analysis utilized a PHI Quantera Hybrid instrument, an upgraded version of the Quantera SXM, with Al Kα (1486.6 eV) as the monochromatic X-ray source, and charge correction was based on the C 1s species at 284.8 eV. Zeta potential measurements, aimed at assessing the surface charge state of particles, were conducted utilizing a Malvern Zetasizer Nano ZS instrument, which employs dynamic light scattering technology for its analyses. Wavelength Dispersive X-ray fluorescence (WDXRF, Bruker S6 JAGUAR) was applied for elemental analysis with full power at 30 kV. ²⁷Al and ¹³C solid-state magic-angle-spinning nuclear magnetic resonance (SSMAS-NMR) was characterized using a Bruker Avance III 300 MHz spectrometer. All spectra were collected at 12 KHz spinning speed. ²⁷Al was collected with a 0.5 s relaxation delay and a 0.03 s acquisition time, while ¹³C direct excitation was collected with 50 KHz 1H decoupling using a 1.5 s relaxation delay and a 0.5 s acquisition time.

A thermogravimetric analyzer (TGA 5500, TA Instruments, USA), equipped with a high-temperature furnace, was employed for thermal stability and composition analysis. The temperature was increased at a rate of 10° C./min in a nitrogen environment, with a consistent flow rate of 20 mL/min. The temperature range for the analysis extended from ambient temperature up to 800° C. Ion concentrations for all samples were analyzed via inductively coupled plasma mass spectrometry (ICPMS Thermo Electron iCAP RQ, Thermo Fisher, USA).

### 1.6 DFT Calculation

The density functional theory (DFT) calculations were carried out with the VASP code. The Perdew-Burke-Ernzerhof (PBE) functional within generalized gradient approximation (GGA) was used to process the exchange correlation, while the projector augmented-wave pseudopotential (PAW) was applied with a kinetic energy cut-off of 500 eV, which was utilized to describe the expansion of the electronic eigenfunctions. The Brillouin-zone integration was sampled by a Γ-centered 5×5×1 Monkhorst-Pack k-point. All atomic positions were fully relaxed until energy and force reached a tolerance of 1×10⁻⁵ eV and 0.03 eV/Å, respectively. The dispersion-corrected DFT-D method was employed to consider the long-range interactions.

In addition, the binding energy (E_{b}) of a complex formed between two molecules, A and B, could be calculated using the following equation:

$${E}_{b} = {E}_{complex} - ( {E}_{A} + {E}_{B} ) \qquad Eq . ( 11 )$$

where E_{complex} is the total energy of the molecular complex of A and B. E_{A} and E_{B} are the total energies of isolated molecules A and B, respectively.

### 2. Results and Discussion for Peg-Modified LDH

2.1 Li/Al-LDH Modification with PEG

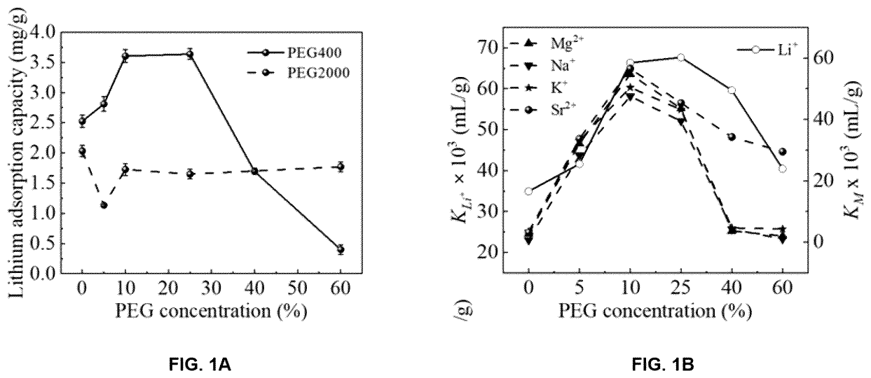

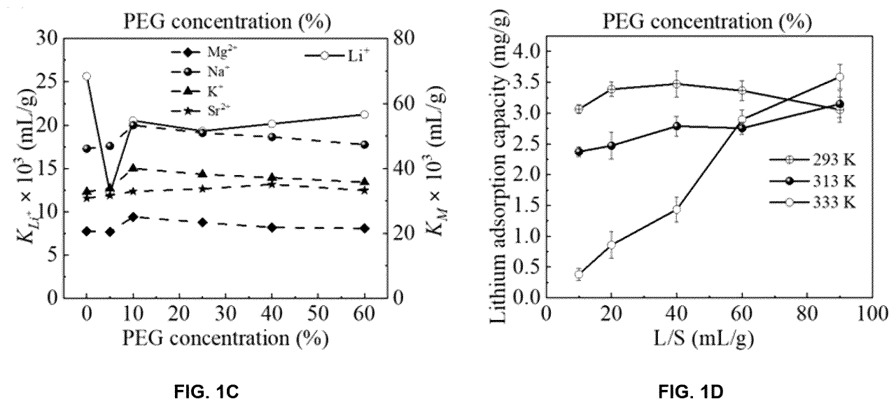

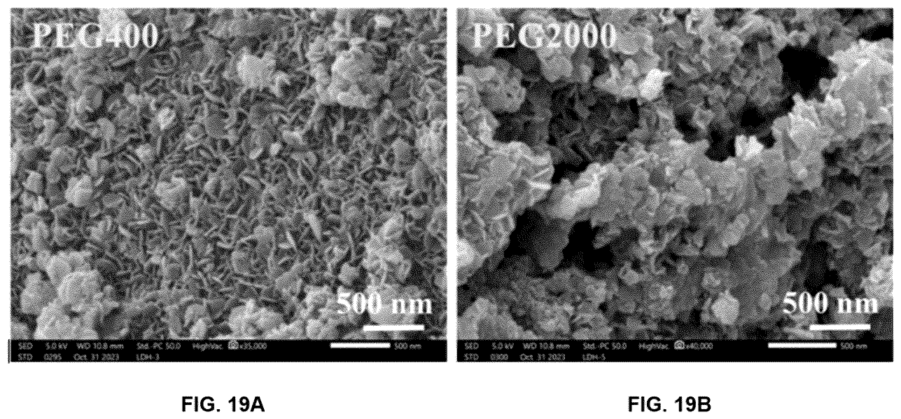

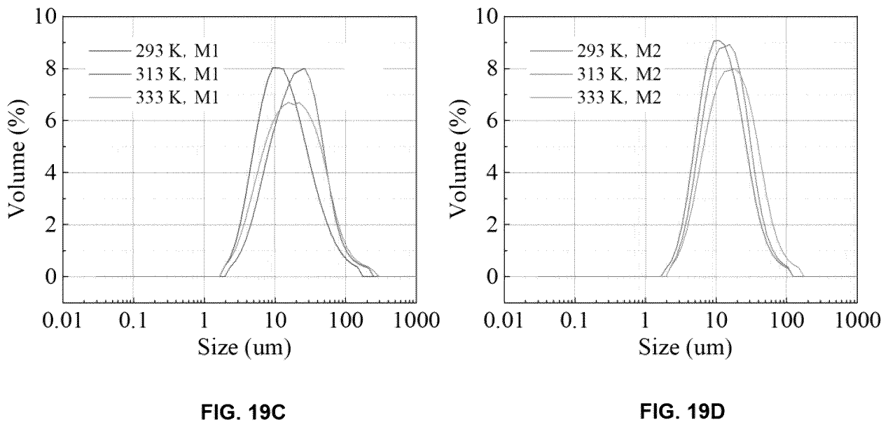

The adsorption performance of PEG400@LDH and PEG2000@LDH in the synthetic brine is shown in FIG. 1A. Regardless of the PEG concentration, modification with PEG2000 consistently caused adverse effects on the adsorption performance of the LDH. Notably, after modifying with the 5% PEG2000 solution, the adsorption capacity dropped from approximately 2.0 mg/g to a minimum value of only around 1.1 mg/g. In contrast, employing PEG400 at specific concentrations remarkedly enhanced the lithium adsorption capacity. The highest adsorption capacity was achieved by modifying with a 10% PEG400 solution, with an increase in the adsorption capacity from approximately 2.50 mg/g to about 3.61 mg/g. In a relatively low PEG concentration range (i.e., 0%-40%), the lithium adsorption performance of PEG400@LDH was better than that of PEG2000@LDH. This contrast can be ascribed to the fact that modification with higher molecular weight PEG (e.g., PEG2000) tends to decrease the surface wettability of the nanoparticles, potentially hindering the adsorption process. Rapid drops in the adsorption capacity occurred when the concentration of PEG400 solution exceeded 25%, likely due to the steric hindrance effect resulting from excessive integration of the polymer into the adsorbent. This effect diminishes both the accessible surface area and the quantity of active sites for adsorption, thereby impairing the lithium adsorption performance. FIGS. 1B-1C illustrates the distribution factor when using PEG400@LDH and PEG2000@LDH as the adsorbents. Obviously, PEG400@LDH demonstrated superior lithium-ion separation in this system, with the distribution factor surpassing 65 when using a PEG400 solution with a concentration of 10%-25%. The morphology and particle size analysis of PEG400@LDH and PEG2000@LDH are shown in FIGS. 19A-19D. PEG400@LDH exhibited a more uniform distribution of flakes, while PEG2000@LDH possessed more aggregates with larger surface pores, likely due to the better dispersion achieved by low molecular weight PEG.

Further investigations were performed to identify the optimal modification temperature and L/S ratio for modifying with the 10% PEG400 solution. FIG. 1D demonstrates the lithium adsorption capacity of 10% PEG400@LDH prepared under different conditions. It was observed that when the L/S ratio was below 60 mL/g, the lithium adsorption capacity tended to decrease with increasing temperature, with 293 K being the most effective modification temperature. This phenomenon can be attributed to PEG melting at high temperatures and subsequent alteration of active sites on the nanoparticle surface. Notably, the lithium adsorption capacity of adsorbents modified at 313 K and 333 K increased with elevations in the L/S ratio. However, the peak adsorption capacity was achieved at an L/S ratio of 20 mL/g for the adsorbent modified at 293 K. This disparity suggests that the PEG dosage for achieving optimal modification performance is closely related to the modification temperature. Although modification under the conditions of 90 mL/g S/L ratio and 333 K reaction temperature led to slightly higher adsorption capacity than the conditions of 20 mL/g L/S ratio and 293 K, the latter conditions were deemed optimal considered the reduced modification costs.

### 2.2 Physiochemical Properties and Modification Mechanisms

Comprehensive physicochemical characterizations were conducted to better understand the modification process and the enhanced adsorption performance of the 10% PEG400@LDH prepared under the optimal conditions. The microscopic morphology of both the unmodified and modified materials is shown in FIGS. 2A-2H. The unmodified particles showcased clusters of nanoscale flakes, assembling into needle-like or rose-like shapes with numerous voids within the structures (FIG. 2A). On the other hand, 10% PEG400@LDH exhibited a unique stacked flake-like morphology. The flakes partially aggregated into a honeycomb structure, showcasing a significant exfoliation (FIG. 2E). Additionally, the single-crystal clusters of the unmodified material are layered in arrangements that are either parallel or perpendicular to each other, accompanied by a pronounced layered configuration (FIGS. 2B-2C). The sharp and precise arrangement of spots on the SAED patterns confirms that these crystals adhere to the regular hexagonal system (FIG. 2D). Nevertheless, upon closer examination of the 10% PEG400@LDH, it was observed that its structure is composed of irregular hexagonal particles clustered together, with varying sizes between 20 to 50 nm (FIG. 2F). This arrangement not only made the layered pattern more pronounced but also enhanced the crystallinity of the material (FIGS. 2G-2H).

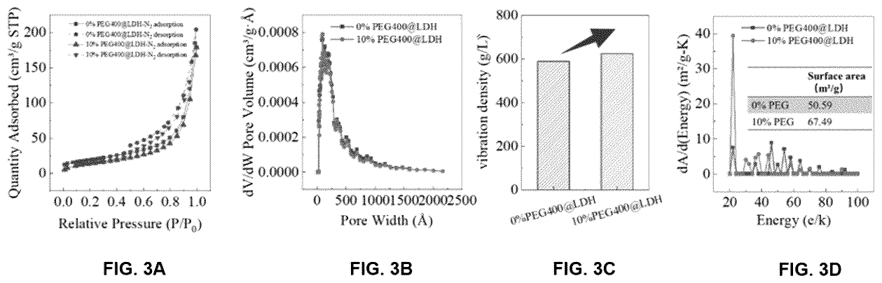

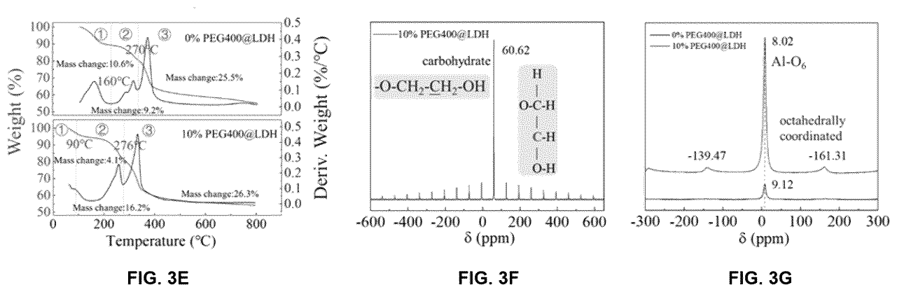

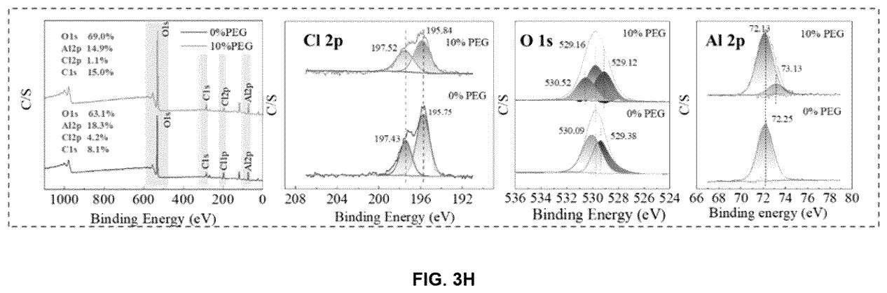

The N₂ adsorption-desorption curves depicted in FIG. 3A provide insights into the pore structure of the material before and after PEG modification. The presence of noticeable hysteresis loops, characteristic of type IV isotherms, suggested that the meso- and micro-porous structure was preserved after modification. FIG. 3B shows that a broader range of pore sizes occurs after modification. The significant alterations in pore structure and surface characteristics underscore the efficacy of PEG400 modification in increasing the active sites available for effective Li⁺ capture. As shown in FIG. 3C, a noticeable increase in the vibration density from 588 g/L to 625 g/L was realized after modification. This is beneficial for enhancing the unit adsorption capacity of the granular adsorbent and brings substantial advantages during subsequent powder granulation stage. Additionally, as depicted in FIG. 3D, the change in surface energy vividly showcases that 10% PEG400@LDH exhibited a wider range of active sites on its surface, enhancing its capacity for lithium adsorption. Furthermore, there was an increase in the specific surface area from 50.59 m²/g to 67.49 m²/g after the modification. Variations in these physical properties not only refined the structure of the material but also enhanced its performance in lithium adsorption.

The thermal properties of the different adsorbents are depicted in FIG. 3E. The pyrolysis process of both the unmodified and modified materials can be segmented into three distinct phases. For the unmodified material, these phases were associated with the loss of free water, intercalated water, and the de-hydroxylation process, exhibiting mass losses of 10.6%, 9.2%, and 25.5%, respectively. However, the thermal degradation of the modified material, 10% PEG400@LDH, involved the loss of free water (4.1% mass loss), intercalated water and PEG (16.2% mass loss), and the de-hydroxylation process (26.3% mass loss). PEG is typically decomposed in the temperature range of 200-250° C., aligning with the noticeable weight loss of the modified material in the similar temperature range. This alignment confirmed the successful integration of PEG chains into the material.

In addition to the enhanced physical properties discussed above, chemical characterizations were also conducted to evaluate the impact of PEG modification on the chemical properties of the material. The chemical composition results shown in Table 2 indicate a significant reduction in the mass concentrations of Al and Cl after modification. This reduction can primarily be attributed to the integration of PEG's long molecular chains into the crystal structure of the Li/Al-LDH, occupying specific sites within the layers and in the interlayer regions.

SSNMR spectroscopy results for ¹³C and ²⁷Al, as displayed in FIGS. 3F-3G, provide valuable insights into the molecular conformation and chemical bond configurations of the materials. The ¹³C spectrum exhibited a pronounced peak at 60.62 ppm, indicative of the carbohydrate configuration within the PEG carbon chain of the 10% PEG400@LDH. Additionally, the ²⁷Al spectrum revealed a sharp peak at 8.02 ppm, suggesting an octahedral coordination of Al—O₆. A subtle peak shift for Al—O₆ indicated a change in the chemical environment of Al₁₃ after PEG modification. Besides, the presence of ²⁷Al peaks at −139.47 ppm and −161.31 ppm in the 10% PEG400@LDH indicated that Al₁₃ was in an octahedral coordination environment, associated with the Keggin structure, which is known for its high positive charge conducive to co-precipitating with lithium ions.

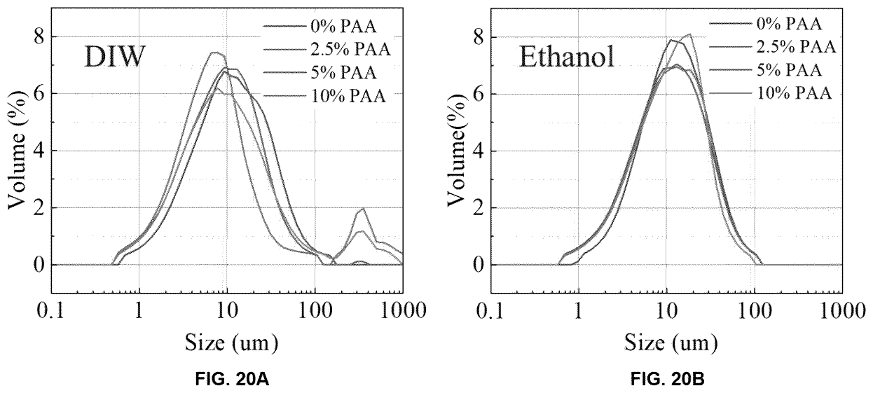

In FIG. 3H, the XPS full spectra confirms that the primary composition of 10% PEG400@LDH remained consistent with that of the unmodified nanoparticles. However, increases in the contents of O and C, accompanied by decreases in Al and Cl, were observed. This aligns with the results presented in Table 2, implying the successful integration of PEG chains within both the layers and interlayers of the nanoparticle, which effectively replaced Al and Cl atoms. Furthermore, the peak areas of the two split peaks of Cl 2p changed from 58.8% and 41.2% to 58.2% and 41.8%, respectively, indicating a change in the chemical environment around Cl atoms. The peak at 195.76 eV shifted to 195.84 eV, indicating Cl⁻ alignment with segments of the PEG long chain, and the peak at 197.43 eV increased to 197.52 eV, suggesting partial Cl⁻ binding to metal ions. Additionally, in the high-resolution O 1s spectrum of 10% PEG400@LDH, a new peak emerged at 530.52 eV, which referred to C—O bonding, further validating the modification of the chemical environment within the LDH structure. The shift from 529.38 eV to 529.12 eV suggested a modification in the environment surrounding the Al—O bonding, indicating the incorporation of segments of the PEG long chain into the Al—O cavities. This finding was supported by conclusions drawn from the Al 2p high-resolution spectrum. Additionally, the two splitting peaks observed at 284.41 eV and 283.13 eV in the C 1s scan spectrum in FIGS. 20A-20B corresponded to C—H and C—O, respectively, highlighting its role in altering the surface and structural properties of LDH nanoparticle for enhanced performance.

TABLE 2
Compositions (mg/L) and pH value of different systems.

| Types | Li | Na | Mg | Sr | pH value |
|---|---|---|---|---|---|
| Shale gas produced water | 74.6 | 41,882 | 1,915 | 34,412 | 2.31 |
| Synthetic produced water | 100 | 40,000 | 2,000 | 30,000 | 4.63 |

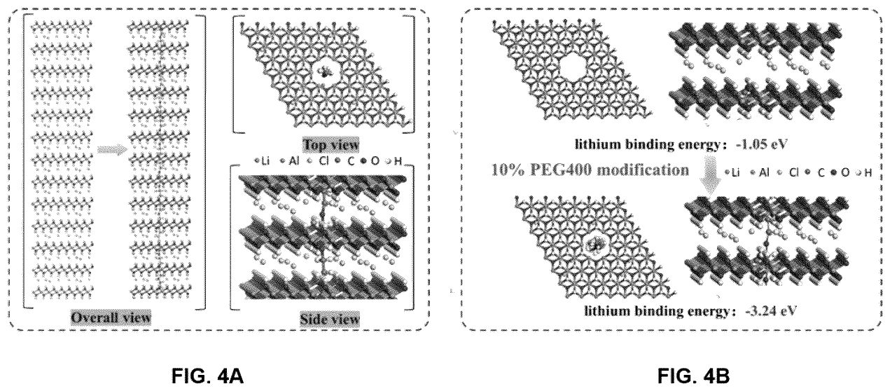

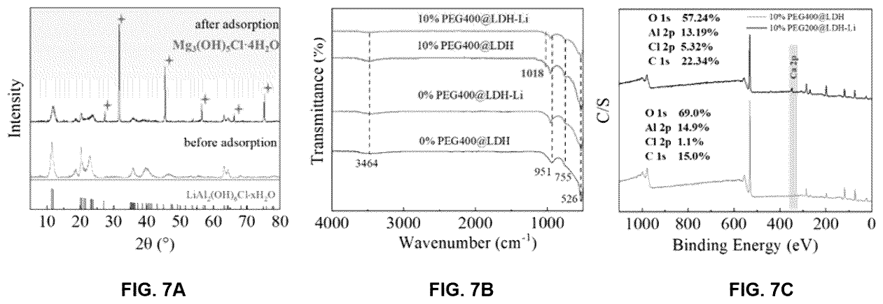

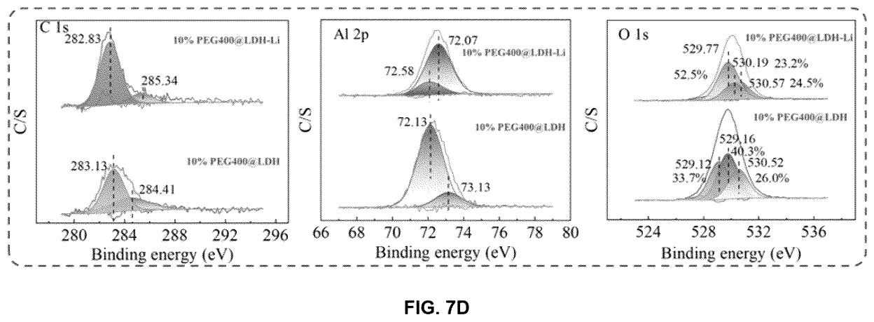

To further visualize the mechanisms of PEG modification and enhanced Li⁺ capture ability on Li/Al-LDH, the optimized arrangement of the structure and variations in lithium binding energy are given in FIGS. 4A-4B. This visualization highlights the complex interweaving of the PEG400 long chains with the LDH layers, presenting a notably orderly pattern of embedding for demonstrative purposes. Within this configuration, aluminum atoms within the layered framework establish new chemical bonds with the (—CH₂CH₂—) molecules of the PEG chain. Additionally, chlorine atoms located in the interlayer region form organic connections with (—CH₂CH₂—) groups within the PEG chain. As shown in FIG. 7B, this structural alteration results in a newly formed lamellar architecture, characterized by a significant increase in the lithium binding energy within the cavities of the lamellar planes, soaring from −1.05 eV to −3.24 eV. It demonstrates a considerably improved capacity for Li⁺ intercalation compared to the original, unmodified structure. The integration of the PEG400 chains not only alters the structural and chemical landscape of the LDH material but also distinctly improves its lithium-ion affinity.

### 2.3 Lithium Adsorption Experiments

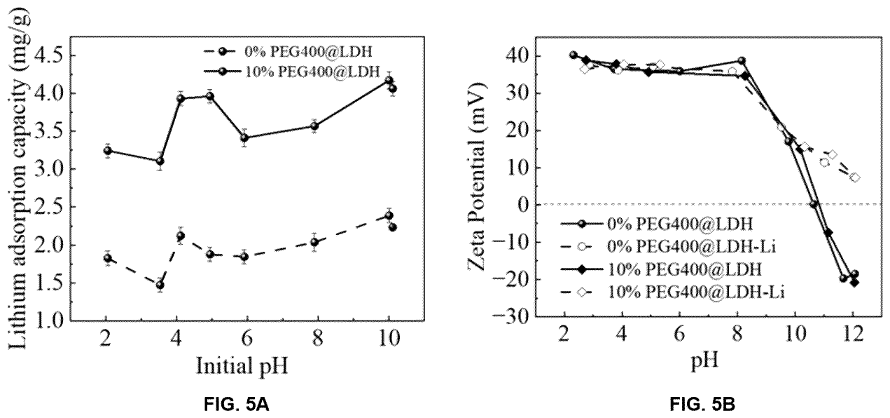

The 10% PEG400@LDH, synthesized under the optimal conditions, was employed to adsorb lithium from the unconventional brine (i.e., the shale gas produced water). The influence of pH on lithium adsorption performance is illustrated in FIG. 5A. Notably, in the acidic pH range, the lithium adsorption capacity peaked at approximately 4.0 mg/g within pH 4-5. Nonetheless, in the basic pH range, the adsorption capacity increased with rising pH, which is largely due to the reduction in positive charge on the surface of the nanoparticles (see FIG. 5B). This reduction decreased electrostatic repulsion between positively charged lithium ions and the surface, thereby improving adsorption efficiency. The zeta potential results depicted in FIG. 5B indicate that the isoelectric points and zeta potentials of the modified and unmodified materials are nearly identical, suggesting that while the addition of PEG influenced the material's physicochemical characteristics, it did not alter the material's surface charge.

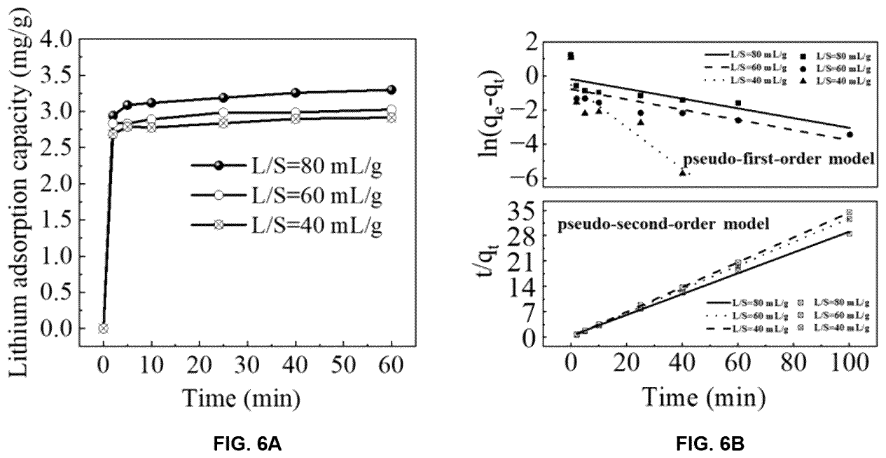

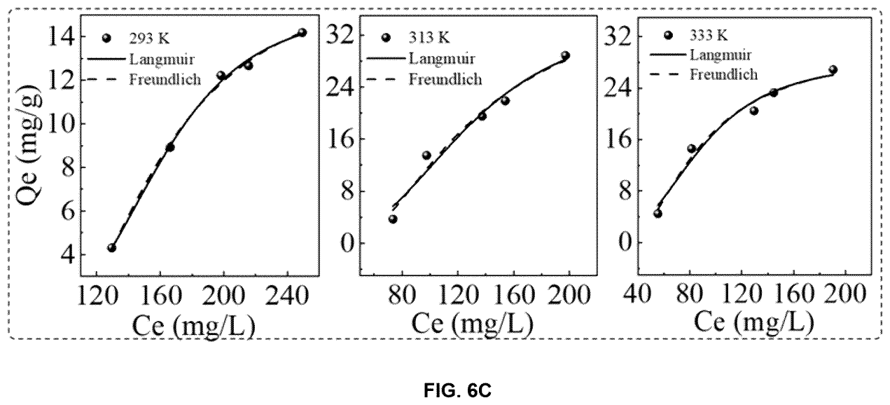

The adsorption kinetics and their corresponding fitting results under various L/S ratios are presented in FIGS. 6A-6B, respectively. It is evident that for all the investigated L/S ratios, rapid lithium adsorption occurred within the initial 2 min, with equilibrium reached after approximately 15 min. However, the equilibrium lithium adsorption capacity increased with increasing L/S ratio. Particularly, at an L/S ratio of 80 mL/g, the lithium adsorption equilibrium reached an impressive value of 3.21 mg/g. This phenomenon can be attributed to the higher concentration of lithium ions available for adsorption in the given environment. Upon examination of the fitting results outlined in Table 3, it can be inferred that the lithium adsorption results aligned more closely with the pseudo-second-order model, implying that the rate-limiting steps in the adsorption process were associated with chemical reaction mechanisms. Additionally, the data from the isotherms, illustrated in FIG. 6C and detailed in Table 3, indicated that lithium adsorption by 10% PEG400@LDH aligned more closely with the Freundlich isotherm model. This indicates that the adsorption process involves multilayer adsorption, suggesting that adsorption occurred not only on the surface but also on the previously adsorbed lithium ions layers, resulting in the formation of multiple adsorption layers.

TABLE 3
XRD results of different adsorbents.

| | 293K, | 293K, | 293K, | 333K, | 333K, | 333K, |
|---|---|---|---|---|---|---|
| | 10 mL/g | 60 mL/g | 90 mL/g | 10 mL/g | 60 mL/g | 90 mL/g |
| d₍₀₀₃₎ (nm) | 0.7726 | 0.7726 | 0.7726 | 0.7799 | 0.7799 | 0.7799 |
| d₍₀₀₆₎ (nm) | 0.3876 | 0.3894 | 0.3894 | 0.3876 | 0.3913 | 0.3913 |

The thermodynamic parameters for the lithium adsorption process using 10% PEG400@LDH are calculated based on the Van't Hoff plot in FIG. S3 and summarized in Table 4. It was evident that ΔG was negative across all examined temperatures, progressively decreasing as the temperature increased. This trend underscores that the lithium adsorption process is inherently spontaneous across the examined temperature spectrum, and its spontaneity enhances as the temperature rises. Furthermore, entropy variations ΔS predominantly drive the process, which is characterized by significant molecular reorganization during adsorption. Observing ΔH to be less than 80 KJ/mol suggests that the process is viable and thermodynamically favored, particularly at high temperatures. Such a modest change in enthalpy indicates that the adsorption process or reaction is energetically efficient and necessitates a lower activation energy. SAED crystal parameters are given below in Table 5.

TABLE 4
Values of the thermodynamic parameters for the
lithium adsorption process using 10% PEG400@LDH.

| | 293K | 313K | 333K |
|---|---|---|---|
| Qₑ (mg/g) | 2.09 | 2.34 | 2.73 |
| Cₑ (mg/L) | 64.00 | 68.10 | 68.6 |
| K_{d} | 0.033 | 0.034 | 0.040 |
| ΔG (kJ/mol) | −8.33 | −8.49 | −8.93 |
| ΔS (J/(mol · K)) | | 39.49 | |
| ΔH (kJ/mol) | | 14.97 | |

TABLE 5
SAED crystal parameters.

| 1/D or 1/r | 1/r | r | d-spacing | d-spacing | |
|---|---|---|---|---|---|
| (nm⁻¹) | (nm⁻¹) | (nm) | (Å) | (nm) | (h k l) |
| 3.390 | 1.6950 | 0.589971 | 2.949852507 | 0.2950 | (1 1 1) |
| 4.657 | 2.3285 | 0.429461 | 2.147305132 | 0.2147 | (1 1 5) |
| 8.671 | 4.3355 | 0.230654 | 1.153269519 | 0.1153 | (2 2 8) |

### 2.4 Adsorption Mechanisms

To unravel the underlying mechanisms of lithium adsorption, a variety of methods were implemented as follows. The XRD patterns shown in FIG. 7A illustrate the changes in the crystal structure before and after lithium adsorption. Remarkably, the material's layered structure was mostly preserved after the lithium adsorption. However, some discernible heterogeneous peaks emerged at 27.3°, 31.6°, 45.3°, 56.4°, 66.2°, and 72.2°, signaling the incremental development of Mg₃(OH)₅Cl·4H₂O. This phenomenon is ascribed to the Mg²⁺ present in the produced water. Furthermore, a comparative analysis of FTIR spectrum (FIG. 7B) before and after lithium adsorption elucidated distinctive peaks at 3464 cm⁻¹, indicative of O—H stretching and intermolecular hydrogen bonding. Peaks at 951 cm⁻¹ and 755 cm⁻¹ are associated with the vibrational modes of interlamellar-OH and Al—O stretching vibrations, respectively, while peaks at 526 cm⁻¹ are indicative of Al—O₆ deformation vibrations. A significant observation is the consistency of peaks at 1018 cm⁻¹ before and after the adsorption, signifying C—O stretching vibrations and suggesting the preservation of the structural integrity and chemical environment of the adsorbent material.

The XPS full-scan spectra before and after lithium adsorption are presented in FIG. 7C. The overall chemical environment remained largely unaltered after the lithium adsorption. Moreover, there was minimal alternation observed in the principal component levels after lithium adsorption, suggesting that the lithium adsorption process did not substantially modify the properties of the material. Nonetheless, a discernible peak at 348.97 eV in the Ca 2p region emerged, indicating the presence of Ca²⁺ originating from the produced water. In FIG. 7D, the C 1s spectra revealed two distinct chemical environments for C atoms, with peaks located at 284.41 eV and 283.13 eV corresponding to C—C and C—O bonds, respectively. Significant shifts in these peaks after adsorption suggest alterations in the environment surrounding the PEG chains, likely due to the partial occupation of Al—O vacancies on the lamellae by lithium ions. Similarly, shifts in the Al 2p splitting peaks after adsorption indicate changes in the chemical environment as a result of lithium intercalation. High-resolution scanning of O 1s showed three split peaks at 529.12 eV, 529.16 eV, and 530.52 eV, corresponding to defect sites related to oxygen vacancies with low oxygen coordination (33.7%), adsorbed oxygen (40.3%), and adsorbed molecular water (26.0%), respectively. Changes in the areas and positions of these O 1s peaks were observed after lithium adsorption, confirming alternations in the chemical surroundings of oxygen atoms on the PEG chains and within the material's interlayers due to Li⁺ intercalation.

### 2.5 Enhancement of Desorption Process

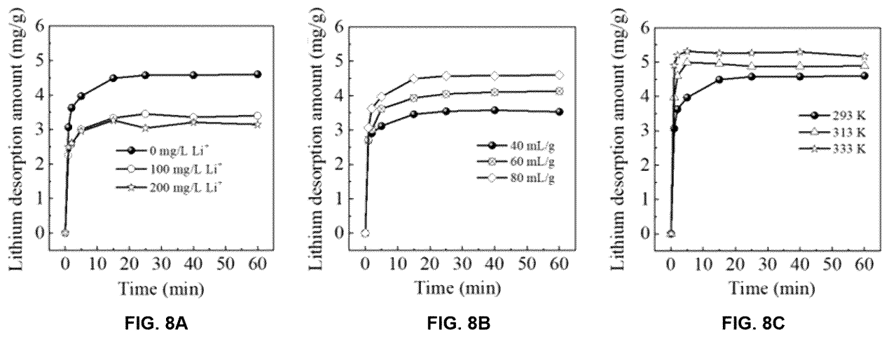

Aligning with the principles of energy efficiency and environmental stewardship, the de-intercalation and desorption processes for lithium have been refined and intensified. The impact of Li⁺ concentration on the desorption process, as given in FIG. 8A, was investigated using a desorption solution prepared by dissolving a certain amount of LiCl in deionized water. The findings indicate that equilibrium was reached within 30 min. However, the desorption efficiency is adversely affected by the presence of Li⁺ in the desorption solution. This inefficiency is attributed to elevated Li⁺ concentrations in the solution, impeding the de-intercalation process, probably due to a minimal difference in ionic strength.

FIG. 8B illustrates the influence of L/S ratio under neutral conditions to determine the optimal desorption performance. The findings revealed a positive relationship between the desorption efficiency and the L/S ratio, achieving the maximum equilibrium extraction rate of 4.6 mg/g at an L/S ratio of 80 mL/g within 30 min. This suggests that a higher volume of desorption solution enhanced the efficiency of the desorption process.

Additionally, the influence of desorption temperature is elucidated in FIG. 8C, showing enhanced desorption efficiency at higher temperatures. In particular, at 333 K, the lithium desorption amount reached up to 5.3 mg/g, verifying that elevated temperatures enhance the Li⁺ de-intercalation activity and may alter the nature of lithium adsorption sites to facilitate a more accessible release of Li⁺. In summary, to guarantee structural stability and adhere to eco-friendly principles, the ideal conditions for lithium desorption involve keeping the process at room temperature, utilizing a neutral desorption solution, and employing an L/S ratio of 40 mL/g.

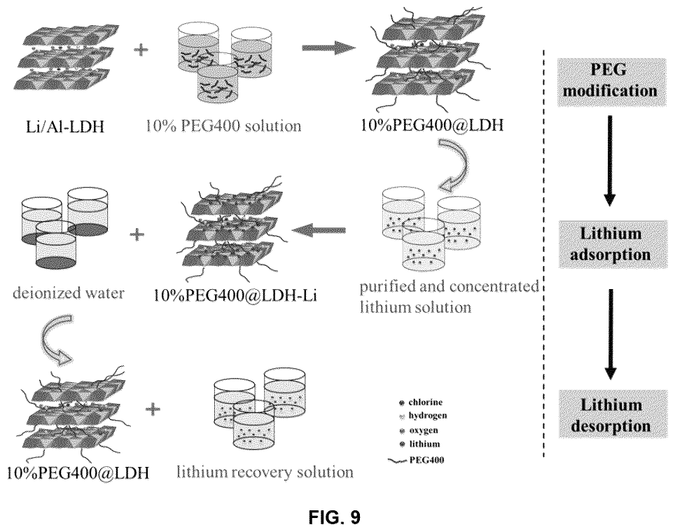

FIG. 9 outlines the lithium extraction process developed based on this study. The process is categorized into three separate phases: PEG modification, lithium adsorption, and lithium desorption. Initially, Li/Al-LDH precursor powder was optimally treated with a 10% PEG solution with a molecular weight of 400 under specific conditions, resulting in a 10% PEG400@LDH adsorbent. Subsequently, the 10% PEG400@LDH adsorbent was employed for lithium adsorption and desorption from lithium resource (i.e., produced water). The unique structure of the adsorbent facilitates the entrapment of Li⁺ through their insertion into the layered cavities of the adsorbent, thereby efficiently sequestering the Li⁺ from the solution. Finally, the desorption procedure was carried out under neutral conditions using deionized water and an L/S ratio of 40 mL/g. This phase is essential because it facilitates the removal of Li⁺ from the laminar structure, effectively releasing them into the desorption solution and successfully achieving the targeted extraction of Li⁺. The entire process is straightforward, highly efficient, and environmentally friendly, highlighting its significance for industrial applications.

### 2.6 Structural and Performance Stability

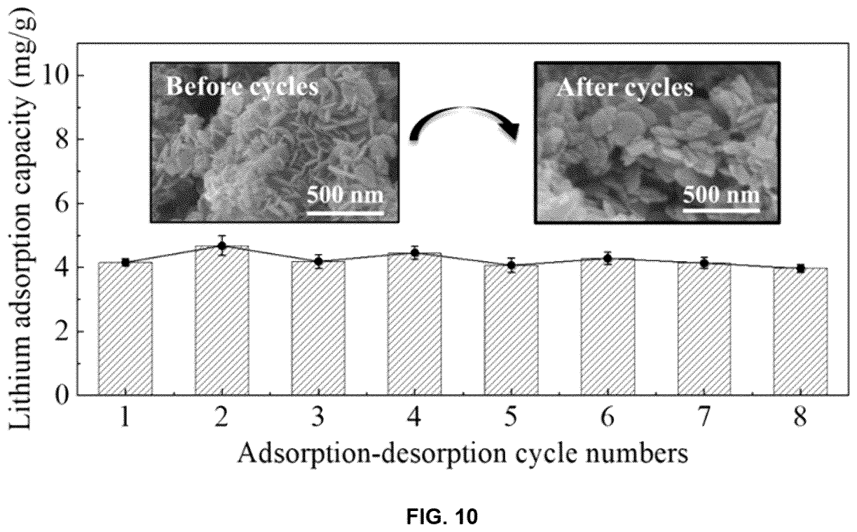

The stability performance of the 10% PEG400@LDH adsorbent during eight cyclic adsorption-desorption experiments is illustrated FIG. 10. It is evident that the lithium adsorption capacity from produced water stabilized at approximately 4.0 mg/g after eight cycles, underscoring the reliability and cyclic durability of the material. Morphological examination offers a perspective on the structural alterations following cycling. The SEM images demonstrated a distinctly enhanced aggregated flake distribution after the cycling process, suggesting the material's structural durability and integrity remained intact through repeated uses. In conclusion, the cyclical adsorption and desorption operations, involving recurrent Li⁺ intercalation and de-intercalation into and out of the lamellar layers, did not affect the adsorption capacity of the 10% PEG400@LDH. The continuous process of adsorption and desorption did not affect the structural integrity and performance stability of the 10% PEG400@LDH.

### 3. Materials and Methods for PAA-Modified LDH

### 3.1 Materials

All reagents employed in this study were purchased from Thermo Fisher Scientific, USA and were directly used without any further purification. The principal components of the shale gas produced water collected from West Virginia, USA and the synthetic produced water are detailed in Table 2.

### 3.2 Synthesis of PAA@LDH

A one-step coprecipitation method was utilized to synthesize Li/Al-LDH. Initially, a mixed solution of lithium and aluminum salts was gradually added to a NaOH solution maintaining a pH value below 7. The resulting precipitates were then washed with deionized water to free the lithium ions and then dried to obtain Li/Al-LDH powder. Subsequently, two distinct approaches were employed to fabricate PAA-modified Li/Al-LDH (PAA@LDH). The first approach (M1) incorporated the addition of the PAA solution during the coprecipitation process, while the second approach (M2) involved blending the PAA solution directly with the pre-formed Li/Al-LDH powder. Additionally, the impacts of two different PAA solvents, deionized water (DIW) and ethanol, on the properties of the modified adsorbent were evaluated.

### 3.3 Adsorption Experiments

All adsorption experiments were performed using a water-bath shaker (Series number 290400, Boekel Scientific, USA) set at a rotational speed of 200 rpm for two hours at room temperature. To optimize the synthesis of PAA@LDH, the synthetic produced water was used as a feedstock. The optimally synthesized PAA@LDH was then utilized to extract lithium from the real produced water, maintaining a L/S of 80 mL/g. For the synthesis optimization of PAA@LDH, various PAA solutions were prepared at different concentrations (w/v %). These solutions were tested with varying dosages of LDH powder, ranging from 10 mL/g to 90 mL/g, and at different temperatures (293 K, 313 K, and 333 K). This comprehensive approach aimed to establish the most effective conditions for enhancing the adsorption capability of PAA@LDH. The adsorption capacity q (mg/g) was calculated as follows:

$$q = \frac{v \cdot ( {C}_{0} - {C}_{t} )}{m} \qquad Eq . ( 12 )$$

where C₀ (mg/L) and Cₜ (mg/L) refer to ion concentration before and after adsorption, m (g) is the mass of adsorbent, and v (L) is the volume of the feed solution. Adsorption kinetic and isotherm models are given in supporting information.

To demonstrate adsorption selectivity, binary solutions with a molar ratio of Li:Me=1:1 were utilized, where Me represents either Na or K. The distribution coefficient K (mL/g) and selectivity factor α were calculated as Eq. (13) and Eq. (14):

$${K}_{Me} = \frac{( {C}_{0} - {C}_{e} ) \cdot v}{{C}_{e} \cdot m} \qquad Eq . ( 13 )$$

$${α}_{Me} = \frac{{K}_{Li}}{{K}_{Me}} \qquad Eq . ( 14 )$$

where C₀ (mg/L) and Cₑ (mg/L) refer to then initial ion concentration and the equilibrium concentration, m (g) is the adsorbents dosage, v (mL) is the solution volume. The subscript Mₑ of K_{Me} and α_{Me} means the metal ions in the solution.

### 3.4 Desorption and Recycling Experiments

All the desorption experiments were carried out using a water-bath shaker as mentioned above. Various parameters were investigated to identify the optimal conditions for enhancing lithium desorption performance. These parameters included L/S of 40 mL/g, 60 mL/g, and 80 mL/g, temperatures of 293 K, 313 K, and 333 K, Li⁺ concentration in the desorption solution (0 mg/L, 100 mg/L, and 200 mg/L), and NaOH concentrations (0 mol/L, 0.05 mol/L, 0.1 mol/L, and 0.2 mol/L). The desorption amount d (mg/g) was calculated according to Eq. (15):

$$d = \frac{v \cdot {C}_{de}}{m} \qquad Eq . ( 15 )$$

where C_{de} (mg/L) refers to the ion concentration in the final solution, m (g) is the mass of used adsorbents, v (L) is the volume of desorption feed solution.

Upon identifying the optimal parameters for lithium desorption, a series of adsorption-desorption cycles were conducted to evaluate the recyclability and stability of the adsorbent. Adsorption was carried out at an L/S ratio of 80 mL/g, with an incubation period of one hour at room temperature. Desorption was subsequently achieved by treating with deionized water for 30 min at an L/S of 40 mL/g and a temperature of 40° C. This cycle was repeated seven times to assess the sustained effectiveness of the process. To ensure the reliability and accuracy of the experimental outcomes, all experiments were replicated three times.

### 3.5 DFT Calculation

The density functional theory (DFT) calculations were carried out with the VASP code. The Perdew-Burke-Ernzerhof (PBE) functional within generalized gradient approximation (GGA) was used to process the exchange-correlation, while the projector augmented-wave pseudopotential (PAW) was applied with a kinetic energy cut-off of 500 eV, which was utilized to describe the expansion of the electronic eigenfunctions. The Brillouin-zone integration was sampled by a Γ-centered 10×10×10 Monkhorst-Pack k-point. All atomic positions were fully relaxed until energy and force reached a tolerance of 1×10⁻⁵ eV and 0.03 eV/Å, respectively. The dispersion corrected DFT-D method was employed to consider the long-range interactions.

### 3.6 Assay

The Mastersizer s3500 from MICROTRAC, USA, equipped with a laser particle size analyzer, was used to evaluate particle size distribution via the wet method. Wide-angle X-ray diffraction (XRD) was conducted with a Bruker D8 over a 2θ range of 5° to 80° at 40 kV and 40 mA. Fourier Transform Infrared Spectroscopy (FTIR) analyses utilized KBr pellets. A Thermogravimetric analyzer (TGA 5500, TA Instruments, USA) operated with a ramping rate of 10° C./min in a nitrogen flow of 20 mL/min, up to 800° C. Surface characteristics were analyzed using a Quantachrome Autosorb-1 through N2 adsorption-desorption isotherms after degassing the samples at 100° C. for 12 hours. Microscopic morphology was examined with a Field Emission Scanning Electron Microscope (FESEM, LEO Zeiss 1550, USA) at 5.0 kV to 20.0 kV. Transmission electron microscopy (TEM) and high-resolution beam techniques (HRTEM with HAADF) were used for detailed structural analysis. Image J software was utilized for analyzing TEM images. Particle surface charge was assessed by zeta potential measurements using a Malvern Zetasizer Nano ZS. Ion concentrations were measured with Inductively Coupled Plasma Mass Spectrometry (ICP-MS) from Thermo Fisher Scientific, USA.

### 4. Results and Discussion for PAA-Modified LDH

### 4.1 Effects of Modification Methods

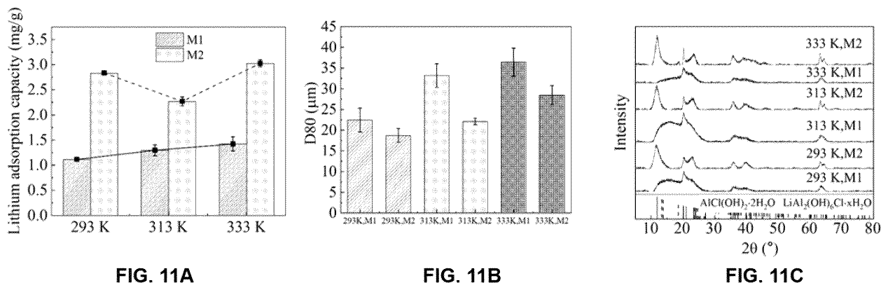

As illustrated in the experimental section, the effectiveness of two different modification methods was first assessed: the inclusion of PAA during LDH synthesis (M1) and the direct mixing of LDH powder with a PAA solution (M2). The lithium adsorption capacities of PAA@LDH, synthesized under various temperature conditions, are presented in FIG. 11A. Notably, method M2 showed significant advantages, especially at 333 K, where the adsorption capacity reached a peak of 3.0 mg/g. In contrast, the adsorption capacities of PAA@LDH synthesized using method M1 were considerably lower than those obtained with method M2. The particle sizes and size distributions of the products from method M1, as shown in FIG. 11B, were larger and more uniform. This variation is attributed to the introduction of PAA during the synthesis, which altered the polarity and ionic concentration of the LDH precursor slurry, subsequently influencing the size of the LDH particles. The crystalline structures of the adsorbents prepared using these methods are depicted in FIG. 11C. The crystal structure of products from method M1 notably differed from the standard LiAl₂(OH)₆Cl·xH₂O structure, aligning instead with AlCl(OH)₂·2H₂O. Given the observed improvements in adsorption capacity and the stability of the crystal structure, method M2 was identified as the more effective modification approach for enhancing lithium recovery.

### 4.2 Effects of PAA Solvent and Concentration

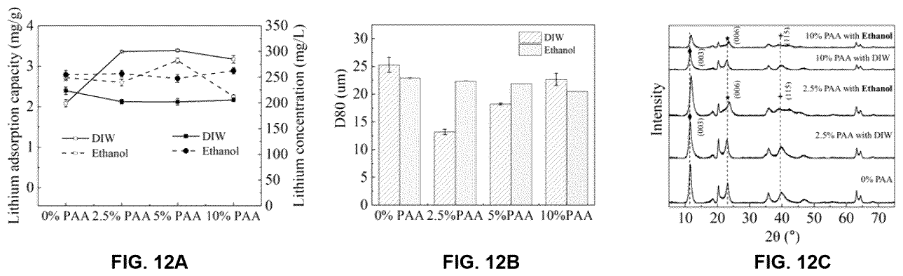

Parametric studies were conducted to identify the optimal conditions for PAA@LDH synthesis using method M2. FIG. 12A illustrates the impact of varying concentrations of PAA, dissolved in two distinct solvents (i.e., DIW and ethanol), on lithium adsorption. The results indicated that enhanced lithium adsorption capabilities were obtained when using DIW as solvent. The different performance of DIW and ethanol might stem from their different polarities. While PAA can dissolve in both DIW and ethanol, it is anticipated that water molecules would from stronger hydrogen bonds with the hydrophilic groups of PAA, such as carboxyl groups (COOH), due to the stronger polarity of water molecules than ethanol molecules. An optimal PAA concentration of 2.5% was identified to maximize lithium adsorption capacity. Excessively high PAA concentrations, such as 10%, led to reductions in the adsorption capacity. The particle sizes of the adsorbents synthesized under various conditions are displayed in FIG. 12B. It is evident that the cohesive inhibition effect of the PAA molecules was significant. PAA, through the interaction of its carboxyl groups with LDH, could inhibit crystal growth and excessive aggregation, thereby reducing the particle size of LDH. Referring to FIGS. 20A-20B, it is evident that using 2.5% PAA dissolved in DIW reduced the D80 value to 12.7 μm, resulting in a more uniform particle size distribution. What's more, the XRD spectra, illustrated in FIG. 12C, show that the intensities of the (006) and (115) crystal faces experienced considerable alterations when using ethanol as solvent, indicating that the adsorbent synthesized under this condition deviated from the standard Li/Al-LDH structure. Moreover, employing 10% PAA led to a more noticeable alternation in the (003) crystal surface compared to the unaltered adsorbent. Overall, the crystalline structure of LDH treated with a 2.5% PAA solution in DIW (2.5% PAA@LDH) most closely matched the standard structure of Li/Al-LDH.

### 4.3 Effects of Modification Temperature and Power Dosage

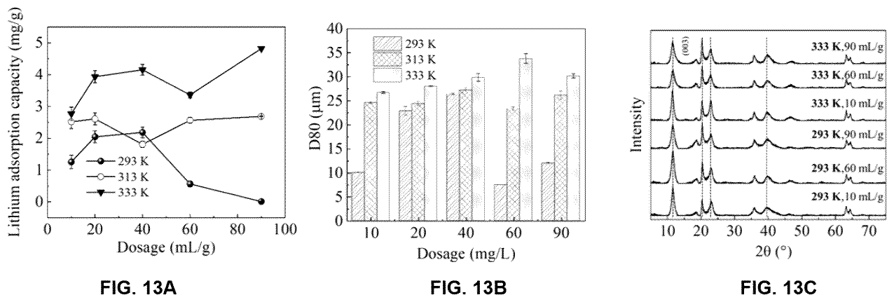

The impact of modification temperature and LDH powder dosage on the performance of the modified adsorbent is illustrated in FIG. 13A. It is observed that higher modification temperatures led to increased adsorption capacities. Specifically, the adsorbent synthesized at a temperature of 333 K with a dosage of 90 mL/g demonstrated the highest lithium adsorption capacity, reaching 4.80 mg/g. Analysis of the particle size data presented in FIG. 13B reveals that the particle sizes of the adsorbent tend to increase with higher synthesis temperatures. Additionally, the particle size distribution, as depicted in Table 3, appears broader. This trend is primarily attributed to the more intense and extensive interaction between the LDH and PAA at elevated temperatures, which promoted the formation of larger adsorbent particles. Besides, FIG. 13C displays the XRD spectra of the adsorbents synthesized under varying conditions, demonstrating that all materials retained a uniform crystalline structure. Corresponding data in Table S2 indicate that the d₍₀₀₃₎ spacing increased with temperature, suggesting an expansion of the interlayer distance. This phenomenon is primarily attributed to enhanced chemical bonding between the LDH and PAA at elevated temperatures. Such interactions facilitated the intercalation of the polymer into the interlayers of LDH, leading to an increased expansion of the layers. In summary, the optimal method for synthesizing PAA@LDH adsorbent with enhanced performance is directly mixing LDH powder with a 2.5% PAA DIW solution under the conditions of 90 mL/g powder dosage and 333 K reaction temperature.

### 4.4 Physicochemical Properties

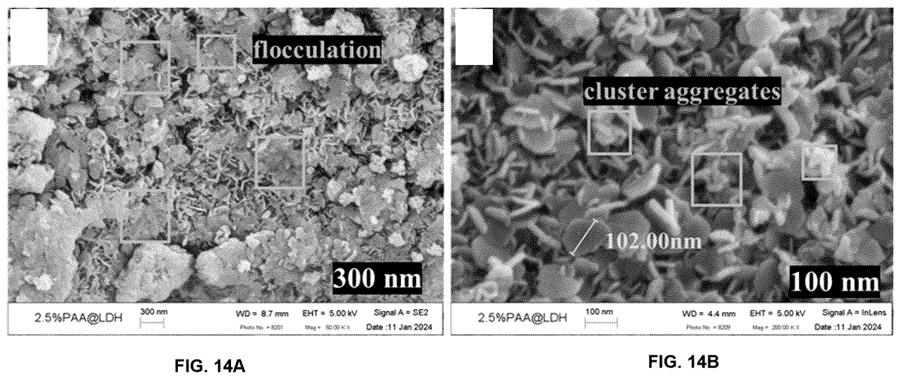

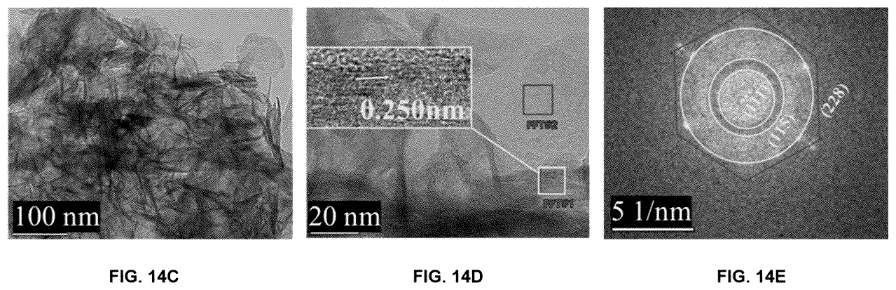

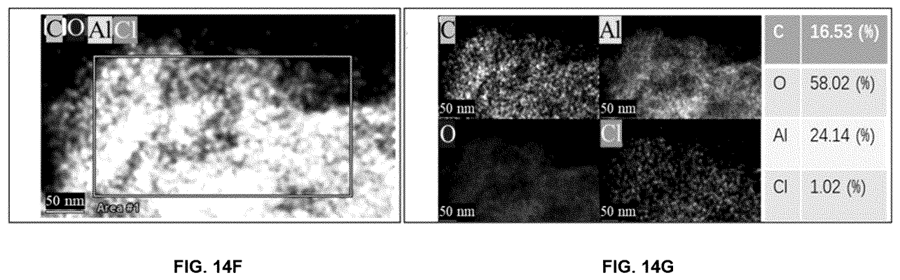

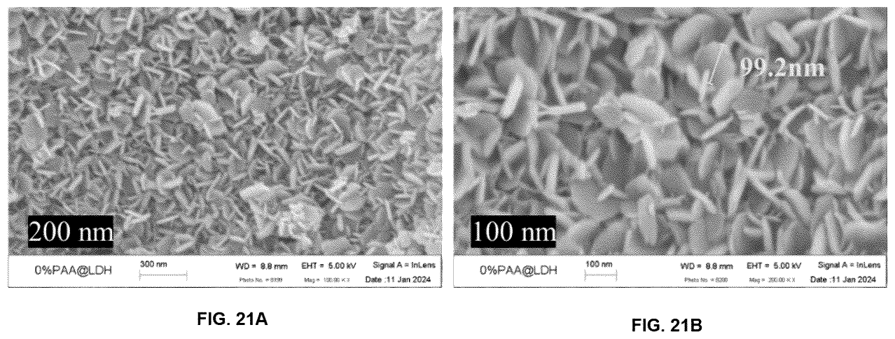

As depicted in FIG. 14A-B, the surface of the 2.5% PAA@LDH features slight continuous flocculation structures characterized by irregular nanosheets. The presence of small-sized cluster aggregates around some of the larger nanosheets was likely due to inter-particle forces. Despite a minor increase in size, the nanosheets predominantly maintained an average diameter of approximately 102 nm. In contrast, the unmodified material (0% PAA@LDH) shown in FIGS. 21A-21B displayed a more uniform and densely packed lamellar structure, with the individual lamellae consistently measuring about 99.2 nm.

TEM analyses were conducted to provide deeper structural insights into the adsorbent at the microscopic level. The findings, displayed in FIG. 14C, reveal the lamellar structure and crystal stacking patterns of the adsorbent. The images highlighted clusters of uniformly shaped, lamellar single crystals. These crystals were oriented either parallel or perpendicular to one another, giving the adsorbent a distinctive acicular/lamellar morphology. FIG. 14D clearly demonstrates that the adsorbent possessed a distinct lamellar structure with a layer spacing of 0.25 nm. Furthermore, the hexagonal spot distribution evident in the SAED pattern of a single nanoparticle, as shown in FIG. 14E, robustly supports the classification of the crystal structure within the hexagonal crystal system. Spacing measurements of the (111), (115), and (228) crystal planes, detailed in Table 3, are 0.2950 nm, 0.2147 nm, and 0.1153 nm, respectively, further confirming the lamellar crystalline structure at the nanometer scale.

The HAADF imaging and elemental mapping results, depicted in FIGS. 14F-G, illustrate the spatial distribution of various elements within the material. Notably, carbon (C) atoms made up 16.53% of the atomic fraction, indicative of the PAA polymer within the structure and the even dispersion of carbon across the nanoparticle's surface. Aluminum (Al) and chlorine (Cl) atoms were also detected, integral to the Li/Al-LDH framework. Interestingly, Cl atoms represented only 1.02% of the atomic composition, which is much lower than that of Al (24.24%). The disparity was likely due to the localization of Cl atoms within the interlayers of the lamellar structure, illustrating the complex chemical and structural organization of the material.

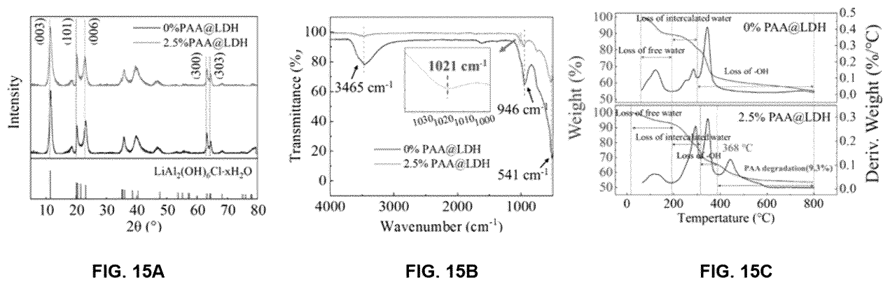

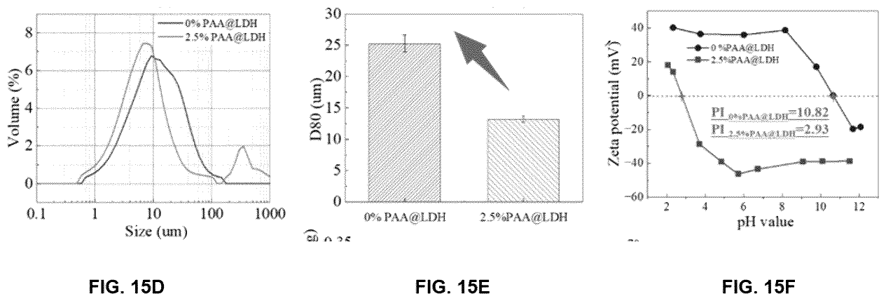

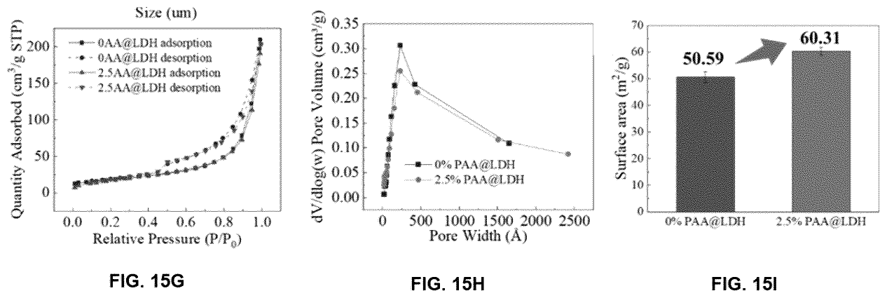

In FIG. 15A, the crystalline structure of 2.5% PAA@LDH is compared with that of the 0% PAA@LDH control. Both materials showed alignment with the standard (003), (001), and (006) crystal planes, typical of the LiAl₂(OH)₆Cl·H₂O compound. This observation implies that the incorporation of the PAA polymer did not modify the underlying crystalline structure of the Li/Al-LDH. Instead, any impact on Li⁺ adsorption appeared to be related to the intrinsic ‘memory effect’ of the Li⁺ cavities within the lamellar layers.

FTIR spectra shown in FIG. 15B reveal distinct peaks at 541 cm⁻¹, 946 cm⁻¹, and 3465 cm⁻¹. These peaks corresponded to the deformation vibration of the Al—O₆ complex, the vibration of interlayer hydroxyl groups (OH), and the stretching vibration of hydroxyl groups, respectively. After PAA modification, a new peak emerged at around 1021 cm⁻¹, which referred to the vibration of the acrylic skeleton. Besides, there were noticeable decreases in the 946 cm⁻¹ and 3465 cm⁻¹ peaks, which corresponded to interlayer water molecules. These decreases were due to the competitive influence of the interlayer PAA chain, resulting in the site's displacement of some interlayer water molecules. The TGA data shown in FIG. 15C reveal that, in comparison to 0% PAA@LDH, there was an extra stage of weight loss between 368° C. and 800° C. This stage was attributed to the degradation of PAA and accounted for a 9.3% loss in mass. Furthermore, the percentages of free water and —OH decreased from 10.9% to 7.3% and from 24.3% to 9.3%, respectively. This phenomenon confirms the finding from the FTIR analysis.

As depicted in FIGS. 15D-15E, the 2.5% PAA@LDH exhibited a more homogeneous particle size distribution and a reduced D80 value, primarily attributed to the alteration of surface charge characteristics induced by PAA modification, facilitating the uniform dispersion of particles within the solution. Zeta potential measurements were conducted to investigate alterations in the surface charge conditions of these materials. As shown in FIG. 15F, notable decreases in the zeta potential of the material occurred after PAA modification, alongside the decrease in the isoelectric point from the original value of 10.82 to 2.93. This phenomenon stemmed from the introduction of negatively charged functional groups into the LDH structure, given that PAA is a negatively charged polymer. Furthermore, the decrease in interlayer water molecules following PAA modification contributed to a reduction in the self-ionization of water molecules. This subsequently diminished the net positive charge on the LDH surface, leading to a decrease in the material's isoelectric point.

The BET results shown in FIG. 15G-15I indicate a consistent pore structure of the material, which is highlighted by the convergence of the adsorbate capillary as the relative pressure neared 0.45. A swift increase in N₂ adsorption leading to saturation was noted, with the saturation adsorption capacity of the 2.5% PAA@LDH adsorbent being estimated at around 216.32 cm³/g. The isotherm featured consistent with a type IV isotherm, accompanied by an H4 hysteresis loop, suggesting a significant presence of both micropores and mesopores within the structure of 2.5% PAA@LDH. A comparative study on the specific surface areas before and after PAA modification showed an increase in the specific surface area of the adsorbent to 60.31 m²/g after modification. This increase would significantly contribute to improved effectiveness in the adsorption process.

### 4.5 Electric Charge Properties

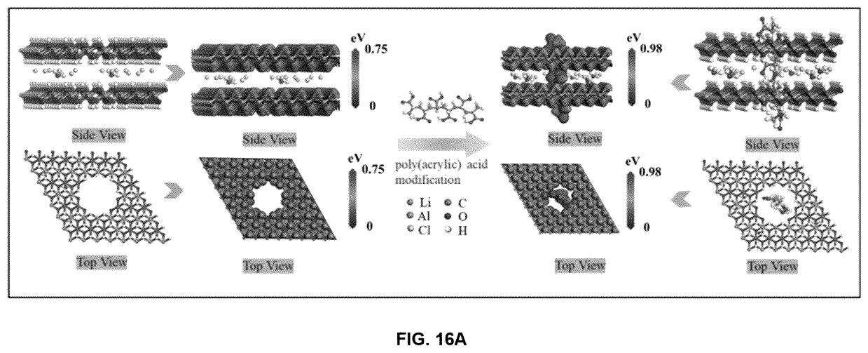

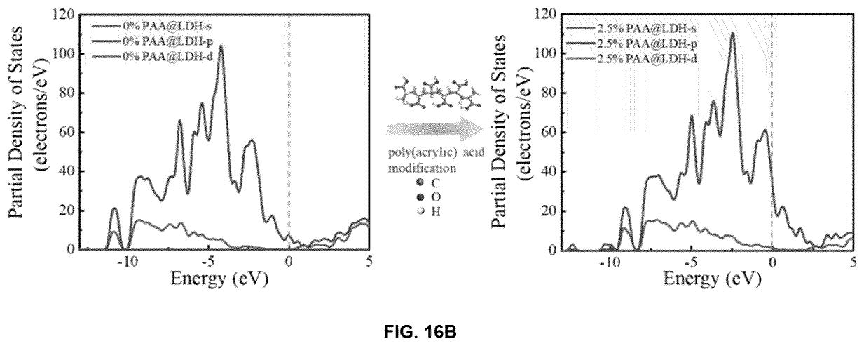

The negative charge of the PAA polymer originates from the ionization of carboxyl groups in the acrylic monomer during polymerization. This inherent negative charge is a defining characteristic of the PAA polymer, significantly influencing the electrostatic properties of the 2.5% PAA@LDH composite. To elucidate the charge distribution within this material, Bader charge analysis was performed, and the results are shown in FIG. 16A. The analysis revealed a marked increase in surface electron density for 2.5% PAA@LDH, where the peak value rose from 0.75 eV to 0.98 eV. This increase indicated a shift toward greater basicity on the LDH surface due to the attachment of negatively charged carboxyl groups, enhancing the overall surface charge density. Consequently, this modification in surface charge properties likely improved the interaction of 2.5% PAA@LDH with positively charged species, such as Li⁺ ions, enhancing its adsorption capabilities

The graphical representation in FIG. 16B provides a detailed insight into the variations in the density of electronic states per unit energy level interval upon PAA modification of the material. It is discernible that the 2.5% PAA@LDH material manifested a notable augmentation in the density of electronic states precisely at the Fermi energy level in comparison to its unmodified counterpart. This observable escalation signified a pronounced increase in electron density attributable to the introduction of carboxyl group from PAA. This rise in electron density significantly contributed to the observed enhancement in the electrical conductivity of the 2.5% PAA@LDH material, as a direct correlation existed between heightened electron density and improved conductivity characteristics. Moreover, the amplified electron density profoundly influenced the material's affinity for binding metal ions, such as lithium ions. The 2.5% PAA@LDH exhibited an enhanced capability to effectively trap and bind lithium ions, primarily facilitated by the intensified interaction between lithium ions and regions characterized by heightened electron density. Consequently, the material demonstrated markedly strengthened binding abilities towards lithium ions, underscoring its heightened efficacy in lithium-ion extraction applications. In conclusion, the augmented charge density on the 2.5% PAA@LDH surface suggested a transformation in surface charge characteristics, alongside an improvement in lithium adsorption properties.

### 4.6 Lithium Adsorption Process

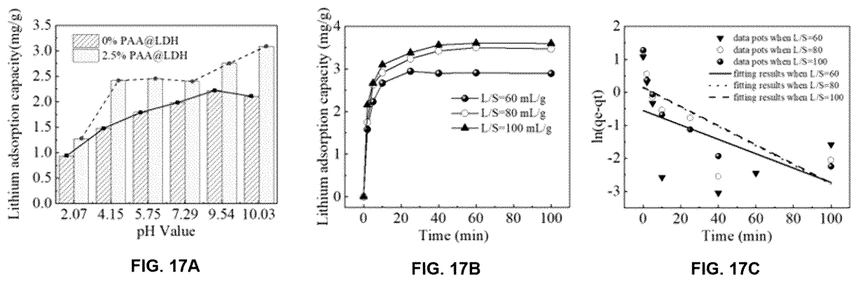

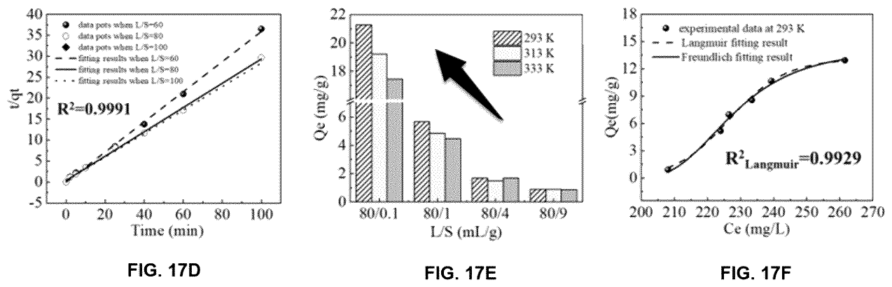

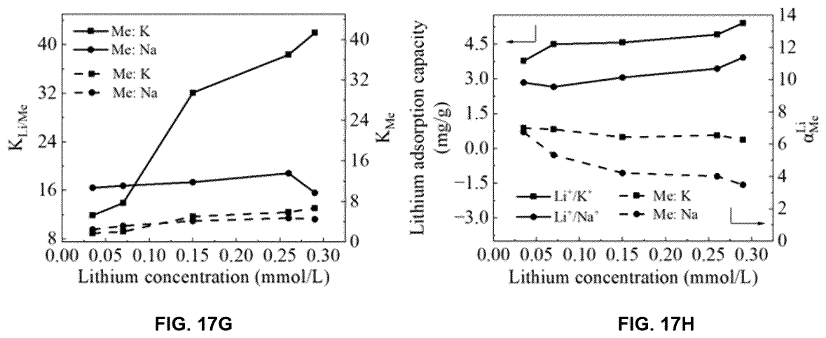

FIG. 17A details how the pH of the solution influenced the effectiveness of adsorbents in capturing lithium. It shows that the adsorption capacity of 2.5% PAA@LDH was superior to that of 0% PAA@LDH across various pH levels. This enhanced performance was attributed to the higher negative charge density on the adsorbent's surface, resulting from the binding of PAA. This highlights the enhanced efficiency of the modified adsorbent in lithium adsorption from produced water. Moreover, a distinct positive relationship between pH and adsorption capacity was noted, mainly due to the expected rise in negative charge density on the LDH surface as pH levels increased. This enhanced the adsorbent's affinity for lithium cation binding.

The kinetics, along with model fitting results, are illustrated in FIG. 17B-D, confirming that equilibrium lithium adsorption was attained within 40 min. Obviously, the observation revealed a direct proportionality between adsorption equilibrium and the L/S ratio. This correlation was attributed to the synergistic effects of heightened solution concentration and augmented effective contact surface area, thereby facilitating the adsorption of a greater quantity of lithium ions. In addition, the pseudo-second-order kinetic model was considered more suitable for describing the lithium adsorption process. This indicates that the adsorption mechanism was influenced by chemical adsorption, resulting in the formation of relatively stable bond structures.

In FIG. 17E, the schematic illustration depicts the influence of temperature on the lithium adsorption, revealing an inverse relationship between adsorption performance and temperature under higher L/S ratios. This phenomenon primarily arose from the potential inactivation or degradation of the modified functional groups of PAA at elevated temperatures. Furthermore, two adsorption isotherm models were employed at 293 K as given in FIG. 17F, indicating a stronger adherence of the lithium adsorption by 2.5% PAA@LDH to the Langmuir isotherm model. This finding suggested that the adsorption process predominantly occurred at uniform adsorption sites on the solid surface, and the adsorption rate was primarily constrained by the availability of these sites.

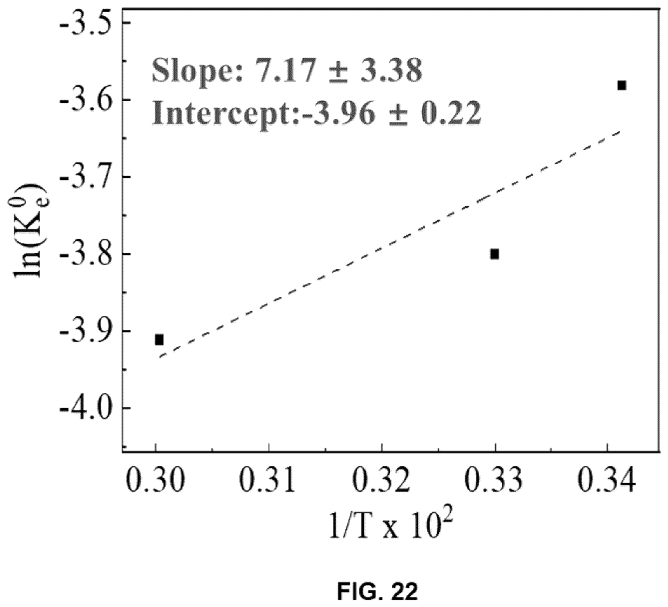

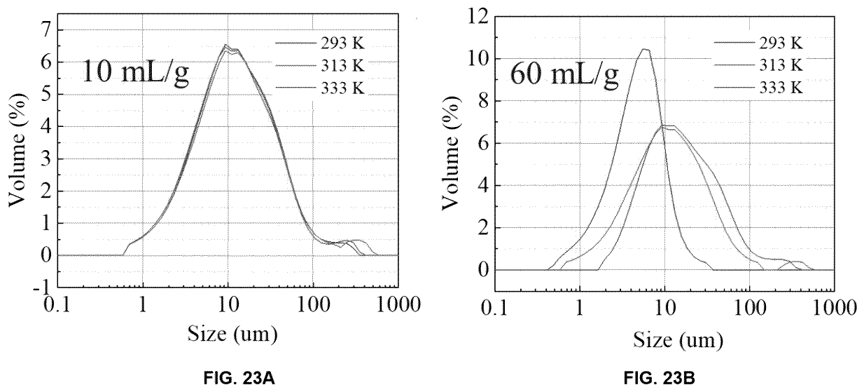

To further investigate the lithium adsorption behavior of 2.5% PAA@LDH, thermodynamic parameters, including enthalpy change (ΔH⁰), entropy change (ΔS⁰), and Gibbs free energy change (ΔG⁰), were calculated. These parameters were obtained from the intercept and slope of the Van't Hoff plot (depicted in FIG. 22) and are summarized in Table 1. Clearly, the negative values of ΔG⁰ and ΔH⁰ indicated the spontaneous and exothermic nature of the lithium adsorption process, which are consistent with the isotherm data. Furthermore, the negative ΔS⁰ suggested that the adsorption process induced a change in the structural arrangement of the system, likely attributed to the formation of chemical bonds during adsorption. In summary, based on the calculated results, the entropy change emerged as the predominant factor influencing the lithium adsorption process.

TABLE 1
Thermodynamics parameters for lithium
adsorption using 2.5% PAA@LDH.

| | ΔG⁰ (kJ/mol) | | | | |
|---|---|---|---|---|---|
| Sample | 293K | 313K | 333K | ΔH⁰ (kJ/mol) | ΔS⁰ (kJ/mol) |
| 2.5% PAA@LDH | −8.73 | −9.90 | −10.83 | −59.61 | −32.94 |

The Li⁺ adsorption selectivity of 2.5% PAA@LDH was evaluated by conducting adsorption in synthetic two-cation solutions. As illustrated in FIG. 17G, the distribution coefficients of Li⁺ over K⁺ and Na⁺ are notably high, suggesting the superior suitability of the material for Li⁺ separation among these three different cations. Furthermore, as depicted in FIG. 17H, the adsorption capacity of Li⁺ increased proportionally with the initial lithium concentration, while the selectivity factor (α) of Li⁺ over K⁺ slightly decreased. Likewise, the α of Li⁺ over Na⁺ showed a declining pattern with rising ion concentration and was slightly lower than that of Li⁺ over K⁺. The remarkable selectivity of Li⁺ over K⁺ and Na⁺ was attributed to the favorable charge effect, ionic radius, and chemical affinity of lithium ions, facilitating their easier penetration into the pores of the adsorbent platelet and binding to the active sites. The overall results indicated that the 2.5% PAA@LDH can be readily utilized to capture Li⁺ with high selectivity.

### 4.7 Recyclability

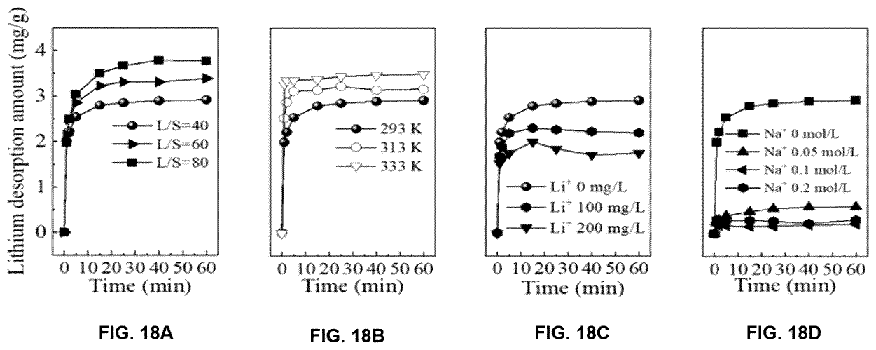

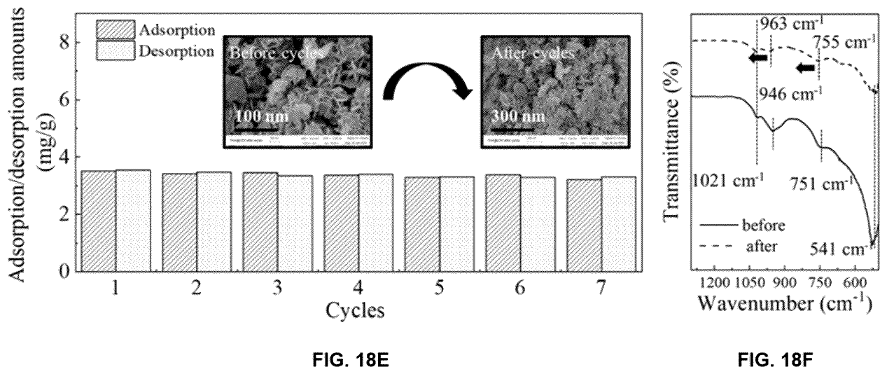

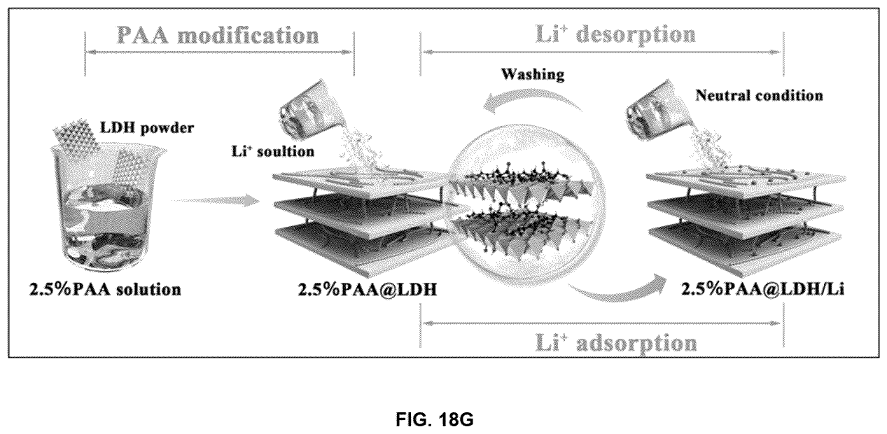

As depicted in FIG. 18A-D, the de-intercalation of Li⁺ ions from the layered structure and the regeneration of functionality for 2.5% PAA@LDH were investigated by varying parameters such as the L/S ratio, temperature, and concentrations of Li⁺ and Na⁺. It was observed that the equilibrium lithium desorption was achieved within approximately 30 min, beyond which no further release of Li⁺ was detected. The study found a direct positive correlation between the amount of lithium desorbed and both the L/S ratio and temperature. Conversely, an inverse relationship was observed with the concentrations of Li⁺ and Na⁺. This behavior can be attributed to higher L/S ratios and increased temperatures, enhancing the thermodynamic energy available for ion exchange, thereby facilitating the release of Li⁺ from the adsorbent. Increased concentrations of Li⁺ and Na⁺ in the solution, however, appeared to hinder this process by altering the thermodynamic equilibrium unfavorably against Li⁺ desorption. The presence of Li⁺ and Na⁺ in the feeding solution diminished the ionic driving force, consequently reducing the capacity of Li⁺ to disengage from the lamellae. To avoid excessive desorption and maintain the structural integrity of the 2.5% PAA@LDH, while adhering to environmental-friendly principles, optimal conditions for lithium desorption and adsorbent regeneration were determined, involving the utilization of deionized water, an ambient temperature of 313 K, and an L/S ratio of 40 mL/g.

To investigate cycling stability, seven adsorption-desorption cycling experiments were conducted. In FIG. 18E, the adsorption and desorption capabilities remained around 3.40 mg/g after seven cycles in produced water, indicating the recyclability of the material for industrial lithium extraction. Besides, no significant alterations in the morphological structure were observed, with the majority of lamellae maintained in their arrangement. Furthermore, the structure and morphology of the material pre- and post-7 cycles of lithium adsorption/desorption are depicted in FIG. 18F. Minor shifts at 751 cm⁻¹ (carboxylate vibrational peak) and 946 cm⁻¹ (interlayer-OH vibrational peak) were detected, primarily attributed to changes in the functional group state on the material's surface following multiple cycling operations. However, peaks at 541 cm⁻¹ representing the Al—O₆ deformation vibration peak and 1021 cm⁻¹ representing the acrylic skeleton vibration peak remained unchanged, indicating the structural integrity of the PAA polymer binding to LDH after multiple cycles. Overall, the 2.5% PAA@LDH demonstrated exceptional proficiency in recycling lithium from produced water, thereby promoting the advancement of clean energy initiatives.

FIG. 18G presents a schematic flow diagram that outlines the modification of LDH powder with a 2.5% PAA solution and its subsequent use in lithium extraction. Initially, the 2.5% PAA solution, prepared in deionized water, was combined with LDH powder to create the 2.5% PAA@LDH adsorbent. The long-chain PAA polymer was irregularly incorporated into the interlayer spaces and plate layers of the LDH, altering its original physical and chemical properties. This modified adsorbent was then utilized for adsorption and selective extraction of lithium ions. Lithium ions were inserted directionally into the Al—O cavities within the lamellae, allowing for highly selective capture of these ions. For the desorption process, deionized water under neutral conditions served as the desorption medium, facilitating the release of intercalated lithium ions, thereby enabling lithium recovery. Throughout this process, the structural integrity of the 2.5% PAA@LDH was maintained, ensuring that the adsorbent remained intact and functional.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A composition comprising:
a Li/Al-LDH substrate; and
a polymer attached to the Li/Al-LDH substrate;
wherein the composition has improved affinity for extraction of lithium from a lithium-containing source material.

2. The composition in claim 1, wherein the polymer is selected from a polyethylene glycol (PEG), a polyacrylic acid (PAA), a polyacrylonitrile (PAN), a polylactic acid (PLA), a polyvinyl chloride (PVC), a polypropylene (PP), a poly (ethylene terephthalate) (PET), a polystyrene (PS), and combinations thereof.

3. The composition in claim 2, wherein the polymer is selected from polyethylene glycol (PEG), polyacrylic acid (PAA), polyacrylonitrile (PAN), and combinations thereof.

4. The composition of claim 1, wherein the polymer has a weight average molecular weight (Mw) less than about 10,000 Da.

5. The composition of claim 1, wherein the polymer is a block copolymer comprising two or more blocks; and wherein each block is independently selected from a polymer block comprising a polyethylene glycol (PEG), a polyacrylic acid (PAA), a polyacrylonitrile (PAN), a polylactic acid (PLA), a polyvinyl chloride (PVC), a polypropylene (PP), a poly (ethylene terephthalate) (PET), a polystyrene (PS), and combinations thereof.

6. The composition of claim 5, wherein the polymer comprises a first polymer block and a second polymer block.

7. The composition of claim 6, wherein the first polymer block and the second polymer block each comprise different polymer blocks.

8. The composition of claim 1, wherein the polymer is a gradient copolymer comprising; wherein the gradient on a gradient from a first gradient polymer comprising a polyethylene glycol (PEG), a polyacrylic acid (PAA), a polyacrylonitrile (PAN), a polylactic acid (PLA), a polyvinyl chloride (PVC), a polypropylene (PP), a poly (ethylene terephthalate) (PET), a polystyrene (PS), and combinations thereof, and a second gradient polymer comprising a polyethylene glycol (PEG), a polyacrylic acid (PAA), a polyacrylonitrile (PAN), a polylactic acid (PLA), a polyvinyl chloride (PVC), a polypropylene (PP), a poly (ethylene terephthalate) (PET), a polystyrene (PS), and combinations thereof; and wherein the gradient is a relatively higher concentration of the first gradient polymer at a first terminus of the gradient copolymer to a lower concentration of the first gradient polymer at a second terminus of the gradient polymer distal to the first terminus.

9. The composition of claim 1, wherein a weight ratio of the polymer to the Li/Al-LDH substrate is about 0.1:1 to about 100:1.

10. A method for preparing a composition comprising a Li/Al-LDH substrate and a polymer, the method comprising the steps:
(a) providing a lithium and aluminum salt solution comprising the Li/Al-LDH substrate and a polymer solution comprising a polymer;
(b) pumping the lithium and aluminum salt solution and the polymer solution into an alkali solution within a container, thereby forming a slurry;
(c) allowing the lithium and aluminum salt solution and the polymer solution to be in contact with each other in the slurry at a temperature and for a time suitable for completion of formation of the composition comprising a Li/Al-LDH substrate and a polymer;
(d) washing the slurry with deionized water; and
(e) drying the slurry forming a powder product comprising the composition comprising a Li/Al-LDH substrate and a polymer;
thereby forming the composition comprising a Li/Al-LDH substrate and a polymer,
wherein the composition comprising a Li/Al-LDH substrate and a polymer comprises enhanced adsorption of lithium.

11. The method of claim 10, wherein the pumping is stopped once the slurry reaches a pH of about 7.0.

12. The method of claim 10, wherein the pumping speed of the polymer solution is between 2 mL/min and 20 mL/min.

13. The method of claim 10, wherein the concentration of the polymer solution is between 5 wt/v % and 50 wt/v %.

14. The method of claim 10, wherein the polymer solution comprises a polymer selected from a polyethylene glycol (PEG), a polyacrylic acid (PAA), a polyacrylonitrile (PAN), a polylactic acid (PLA), a polyvinyl chloride (PVC), a polypropylene (PP), a poly (ethylene terephthalate) (PET), a polystyrene (PS), and combinations thereof.

15. The method of claim 10, wherein a ratio of the polymer solution to Li/Al-LDH is 10 mL/g to 90 mL/g.

16. The method of claim 10, wherein about 50% to about 100% of the polymer present initially in the polymer solution is incorporated into the composition comprising a Li/Al-LDH substrate obtained following step (e).

17. A composition comprising a Li/Al-LDH substrate and a polymer made the method of claim 10.

18. A method for extraction of lithium, the method comprising:
(a) providing a lithium adsorbent composition; and
(b) contacting the disclosed lithium absorbent composition with a water-byproduct obtained from shale gas production;
wherein the disclosed lithium absorbent composition is the composition of claim 1.

19. The method of claim 18, wherein the concentration of lithium in the polymer-modified Li/Al-LDH solution is between 100 mg/L and 200 mg/L.

20. The method of claim 18, wherein the liquid and solid ratio during the adsorption process is between 40 mL/g and 90 mL/g.
